(19) United States
(12) Patent Application Publication
(10) Pub. No.: US 2019/0301648 A1
(43) Pub. Date: Oct. 3, 2019

(54) ELECTRONIC QUICK CONNECT AND QUICK DISCONNECT SYSTEM

(71) Applicant: Erik Leckner, Fallbrook, CA (US)

(72) Inventor: Erik Leckner, Fallbrook, CA (US)

(21) Appl. No.: 15/937,497

(22) Filed: Mar. 27, 2018

(51) Int. Cl. F16L 37/084; G01M 3/40

(52) U.S. Cl. CPC F16L 37/084; G01M 3/40

(57) ABSTRACT

An electronic quick connector for forming a severable connection in a fluid system, comprises: a body having a bore therethrough, wherein the body comprises (i) an attachment end configured to connect the bore in fluid flow relationship to a fluid flow channel, and (ii) a coupling end configured to connect the bore in fluid flow relationship to a coupling end of a further electronic quick connector; a holding mechanism configured to secure the coupling end of the electronic quick connector in a receiving opening of a coupling end of the further electronic quick connector; and at least one sensor configured to: (i) detect a plurality of coupling conditions of the electronic quick connector and the further electronic quick connector, wherein the coupling conditions include the connected condition and a disconnected condition, and (ii) provide an electronic signal representing the coupling condition detected by the at least one sensor.

### CROSS-REFERENCE TO RELATED APPLICATIONS

This application claims the benefit of priority of U.S. non-provisional patent application Ser. No. 15/276,874, filed Sep. 27, 2016, the disclosure thereof incorporated by reference herein in its entirety.

### FIELD

This disclosure relates generally to connectors for fluid systems and vessels that are quickly connectable and disconnectable from each other, and more particularly to a quick connector having means to sense whether a proper connection has been made between the components of the quick connector using sensors.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

Typically, quick connect couplers allow a user to merely push two segments (or portions) of the coupler together to connect a fluid line. To disconnect the fluid line, the user moves an outer cylindrical sleeve against its engineered bias and the two segments separate.

Quick connect and quick disconnect systems, also referred to as coupler systems, are utilized in wide variety of irrigation, industrial, household, plumbing, hydraulic, and commercial applications. One application for coupler systems is for landscape and lawn use. Fluids, such as water, are frequently delivered from one vessel to another through a fluid system.

A quick coupler system typically is a connector on the end of a hose to quickly connect or couple it with another hose or with a spigot or a hose appliance, such as an irrigation sprinkler. It is usually made of steel, brass, stainless steel, aluminum or plastic, or a combination thereof.

Coupler systems typically include a first connector and a second connector. The first connector is typically associated with a fluid device and the second connector is typically associated with a fluid conductor. For example, a coupler system is configured for use with a fluid device provided as a water spray nozzle and a fluid conductor provided as a garden hose. The first connector is connected to the water spray nozzle and the second connector is connected to the garden hose. The coupler system makes simpler and easier connecting and disconnecting the spray nozzle from the hose, as described below, with reference to a typical connection of a garden hose and a water spray nozzle.

The typical hose includes an internally threaded end portion that is connected to a spigot and an opposite externally threaded end portion to which fluid devices are connectable.

To connect a typical spray nozzle to the externally threaded end portion, the user generally first stops the flow of water through the hose via a spigot. The user then aligns threads of the water spray nozzle with threads of the externally threaded end portion of the garden hose. Then the user rotates the spray nozzle relative to the hose to mechanically and to fluidly connect the water spray nozzle to the garden hose until the water spray nozzle is tightly fastened to the hose. A hand tool, such as a wrench, may be used to rotate the water spray nozzle or to fix the hose during the rotation of the water spray nozzle.

The above described process is often inconvenient since the process requires sufficient strength and skill to rotate the water spray nozzle to tightly couple the nozzle to the hose. Second, the connection of the water spray nozzle to the hose is subject to leaking by improperly aligning the threads or not sufficiently fastening the connectors to each other. Third, it requires time to connect and disconnect fluid devices and fluid conductors. Fourth, a user may inadvertently fail to connect the couplers.

Quick coupler systems attempt to simplify the above described process by making connection of the water spray nozzle to the garden hose quick and easy. Coupler systems typically include a male connector and a female connector one of which includes a locking feature. To connect the connectors, the male connector is received by the female connector and the locking feature is engaged. To disconnect the connectors, the locking feature is disengaged and the male connector is separated from the female connector. The structure of the male connector and the female connector, as well as the method of operating the locking feature, varies between different manufacturers, types, and models of coupler systems.

Even though coupler systems seek to simplify connection of a fluid device to a fluid conductor, coupler systems typically experience various issues. First, some coupler systems include a locking feature that is difficult to engage and/or disengage. Second, some coupler systems are quick to connect and quick to disconnect, but are prone to leaking without any indication that there is a leak due to an improper connection. Third, an improper connection between the male member and female connector body of a quick connector coupling can have negative effects on the overall fluid line system. At the very least, a leak in the fluid system will occur at the site of the improper connection if the connector does not have an auto shut off mechanism. Thus, a reliable and accurate means for verifying a proper connection between the male member and female connector body is advantageous.

In addition to being able to quickly connect and disconnect a fluid device from a fluid conductor, some users desire the ability to control the flow of the fluid through the fluid device. For this reason, manufacturers have developed adjustable valves, which are placed in series with the fluid device and the fluid conductor. The adjustable valve is typically moveable between a position of low fluid flow and a position of high fluid flow. The adjustable valve assembly typical makes use of ball or disk valves. These types of adjustable valves work well for controlling fluid flow. However, the typical adjustable valve is not usable in combination with the typical coupler system due to the number of individual components required. Additionally, even if the adjustable valve is usable with the coupler system it typically results in a cumbersome collection of components that is subject to leaking. The mechanically adjustable valves are also difficult to accurately adjust to a specific flow level.

A number of methods and mechanisms exist for verification of proper connection of a quick connector. The coupling may be checked by tugging or pulling on one or more of the connecting members. An improper connection is obvious if a connecting member disengages another connector member. Reliance on physical inspection, however, has numerous disadvantages. The quick connector may be inaccessibly located, for example, where a spigot is positioned behind shrubbery, making accurate inspection difficult and burdensome for a user. Further, the force on a connecting member to disengage the connector may not be sufficient to cause the connectors to disengage, even though the connection is improper. A user may altogether inadvertently fail to connect a coupler system. A user may also inadvertently fail to lockingly engage a coupler system where the male connector was inserted into the female connector but not properly locked into the female connector.

It is also possible to audibly verify a proper quick connection. Generally, as the male member is inserted into the female connector body, a click is heard when a connecting member locks into place. This method of verification is also inadequate in several respects. The click may be too quiet or inaudible, making the detection of locking difficult. Background noise can make the task even more difficult, such as a lawnmower operating in the background.

Today, visual methods of verification have proven to be the most reliable in the field of quick connectors. Different mechanisms and methods for visual verification of proper connection of a fluid quick connector system are illustrated in various patents, including, but not limited to, U.S. Pat. Nos. 8,960,727, 6,860,515, 6,851,721, 6,010,160, 5,441,313, 5,226,679, 5,178,424, 5,152,555, 5,069,424, 4,979,765, 4,948,176, 4,946,205, 4,925,217, 4,915,420, 4,913,467, 4,895,396, 4,793,637, and 4,753,458.

The techniques and methods of visually verifying connections shown in these patents have various shortcomings. Some depend on the position and design of an indicator device at, or in the close proximity of, the quick connector itself. As with methods of manual physical inspection, the usefulness of such indicators is limited if the connector is inconveniently and inaccessibly located or difficult to visualize. The indicator mechanisms utilized in some of the prior connectors are sometimes complex and may extend beyond an objectionable amount from the connector body itself. Furthermore, the indicator mechanisms employed do not have any means for viewing the indicators in the dark or from a remote location.

As described above, one way to achieve proper connector position is to indicate the connection status on the device itself. The problem with this solution is that if the connector is not easily visible, the connection may not be verified properly. This solution also requires the user to examine the connections each time before use, and that is neither desirable nor dependable, especially in the conditions where hose end devices and fluid sources are frequently changed. For example, a landscaping team may frequently change fluid equipment during a landscaping service visit. As another example, a pool service team may frequently service robotic pool cleaning systems which involve hoses, canisters, pool vacuums, and the like.

In other prior fluid connectors, a proper connection is signaled by complete physical disengagement of an indicator device from a connector body. Upon proper connection, an indicator device becomes freely moveable on the male or female member of a coupling or completely separable from the coupling, making verification of a proper connection easy. These prior devices have been deficient, however, in that a potential exists to achieve a proper connection without release of the indicator device. In such cases, a false signal of an improper connection is given, requiring expenditure of time and effort to inspect the connection.

As described above, users may inadvertently fail to connect all the components in a fluid system. Forgetting to connect a hose end device ends up costing a homeowner money. Lawn irrigation systems vary from home to home, which might feature hundreds of sprinkler heads, several hose end devices, a plurality of garden hoses, and miles of pipes and wires on larger sized properties. Each zone of the property has its own requirements and may be designed to utilize different types of watering devices, such as sprinkler heads and hose end devices. For example, a flower bed may have the simple watering requirement of using a garden hose nozzle. If such a device is required, and a user opens a spigot valve before verifying that the fluid system is properly connected, water leakage can end up costing the homeowner money, even when the connectors, hose, and devices themselves are leakproof. As another example, a zone may require a set of sprinklers. If the fluid system is not properly connected, the lawn or plantings will not receive water, which is undesirable and can end up damaging the lawn or plantings over an extended period of time.

For at least the above-described reasons, further developments in the area of quick connect and quick disconnect systems for fluid systems are desirable. The embodiments describe herein overcome deficiencies in the prior art.

### SUMMARY

The details of one or more implementations are set forth in the accompanying drawings and the description below. Other features will be apparent from the description and drawings, and from the claims.

Various embodiments comprise an electronic quick connect and disconnect coupling which includes respective male and female electronic connectors having respective sensors which provide an indication of a coupled condition. The coupling is particularly useful for applications where indication of the proper coupling of the connectors is desirable such as for connecting fluid sources to fluid devices.

It should be understood that these aspects are presented merely to provide the reader with a brief summary of these certain embodiments and that these aspects are not intended to limit the scope of this disclosure. Indeed, this disclosure may encompass a variety of aspects that may not be set forth below.

According to an exemplary embodiment of the present disclosure, an electronic quick connect/disconnect system comprises: a first component having a tube coupling end; a second component having a tube coupling end with a receiving opening therein to receive the tube coupling end of the first component; one or more electronic sensors, wherein at least one of the sensors is configured to sense a coupled condition between the first and second components when in a coupled condition; an electronic locking mechanism associated with the first and second components to lock them together in locked condition, allow easy disconnection when desired, and provide for detection of locked condition; a controller configured to generate a message responsive to the current condition provided from the at least one sensor; one or more indicators configured to provide a message responsive to the controller generating the message; and a wireless transceiver configured to wirelessly transmit a message to a wireless base station, device, or app.

In this embodiment, a proper connection is signaled by the indicator whenever complete physical engagement of one connector body to the other connector body occurs. Upon proper connection, the indicator provides a visual, audible, or tactile indication to the operator, and the transceiver wirelessly transmits an indication message. A disconnection is also signaled by the indicator whenever physical disengagement of one connector body to the other connector body occurs. Upon disconnection, the indicator provides a visual, audible, or tactile indication to the operator, and the transceiver wireles sly transmits an indication message to another device. Since the indicator and wireless transceiver indicate connections and disconnections, a false signal of a connection or disconnection does not occur.

According to another exemplary embodiment of the present disclosure, an electronic quick connect/disconnect system comprises: a first component having a tube coupling end; a second component having a tube coupling end with a receiving opening therein to receive the tube coupling end of the first component; one or more electronic sensors, wherein at least one of the sensors is configured to sense a coupled condition between the first and second components when in a coupled condition; an electronic locking mechanism associated with the first and second components to lock them together in locked condition, allow easy disconnection when desired, and provide for detection of locked condition; at least one electronic valve; a controller configured to generate a message responsive to the current condition provided from the at least one sensor; one or more indicators configured to provide a message responsive to the controller generating the message; and a wireless transceiver configured to wirelessly transmit a message to a wireless base station, device, or app. The controller is further configured to control the valve to each of a plurality of flow positions by positioning the valve in a respective one of a plurality of flow control positions by an electromechanical mechanism. The electronic valve is lockable in each of the plurality of flow control positions. Operation/adjustment requirements are determined at least in part using the current values of one or more other settings variables from one or more sensors, and the requested value of the electronic valve flow control position. For example, if the current value of the coupled condition is set to “disconnected”, and the requested value for the flow control position of the valve is “open”, the controller may be programmed to not open the valve.

The locking aspects may be one of the many systems today in the field of quick connectors. For example, the locking mechanism may include at least one ball retaining hole through the coupling end of the female connector with a ball positioned in the at least one ball retaining hole. The male and female connectors are held together by holding the ball in the at least one ball retaining hole in inward position to extend into the ball receiving recess. At least one of the sensors detects when the system is in a locked condition. The controller is configured to generate a message responsive to the current condition provided from the at least one sensor

At least one indicator is configured to provide a message responsive to the controller generating the message. A wireless transceiver is configured to wirelessly transmit a message responsive to the controller issuing the request to transmit a message.

The indication mechanism may include at least one luminous element on or within the housing of the female connector. The indication mechanism may also include at least one luminous element on or within the male connector. The luminous element is typically comprised of light emitting diodes, a cover, and embedded circuitry. When the male and female connectors are connected, the luminous elements illuminate in a solid or flashing state. The controller may be programmed during manufacturing, or after manufacturing at the time of pre-sale, or after sale of the connector system to a user. When the male and female connectors are disconnected, the luminous elements may also illuminate in a solid or flashing state, depending on how the controller was programmed. The luminous elements may also illuminate in varying colors, depending on the programming of the controller.

The wireless mechanism may include at least one communications protocol, such as Wi-Fi, Bluetooth, Bluetooth Low-Energy (BLE) or Bluetooth Smart, ZigBee, Z-Wave, 6LowPAN, Thread, Cellular, Sigfox, and the like. The wireless transmitter transmits data in the form of an electronic message to a base station, other devices and apps in a wireless network. In some embodiments, the transmitter behaves like a beacon, where it repeatedly transmits a signal that other devices and apps can receive. The connector simply transmits a small amount of data that notifies a base station, app or other device what the current connection state is. The beacon may make use of Bluetooth Low Energy (BLE), a standard beacon technology.

Some connectors may use small lithium batteries, AA or AAA batteries, or the like for power.

In some embodiments, a sensor is a proximity sensor configured to sense the current proximity of the first connector from the second connector. In these embodiments, a proper connection is signaled whenever a proximity sensor on one connector detects a complete engagement to the other connector's corresponding sensor. A disconnection is also signaled whenever physical disengagement of one connector body from the other connector body occurs.

In other embodiments, a sensor of a quick connector is a magnetic sensor configured to sense a magnet in the other connector. In these embodiments, a proper connection is signaled whenever a magnetic sensor on a first connector detects the engagement to the second connector's magnet. A disconnection is also signaled whenever the magnetic sensor on the first connector detects a disengagement from the second connector's magnet.

In other embodiments, the sensor of a first connector is a RFID reader configured to sense a RFID tag in the second connector. The RFID tag on the second connector contains an integrated circuit and an antenna, which is used to transmit data to the RFID reader on the first connector. The RFID reader then converts the radio waves to a data message that is sent to the controller. A proper connection is signaled whenever the RFID reader detects the engagement. A disconnection is also signaled whenever the RFID reader detects a loss of signal from the corresponding RFID tag. If the embodiment further comprises a wireless transceiver, a connection message is then transmitted through a communications interface to a remote system, where the transmitted message can be used to indicate the connection to users in proximity of the remote system. The message data can further be stored in a database and later analyzed.

In yet other embodiments, the sensor of a first connector senses a sensor in the second connector. In these embodiments, the sensors are smart devices whose purpose is to detect events or changes in each other. Upon proper connection, the sensors on each make verification of a proper connection and a disconnection. The sensors may further detect each other while simultaneously nulling false signals from other devices. The coupling makes use of at least one sensor on each connector to improve the quality and reliability of a connection. Often, especially in outdoor irrigation environments, there are other devices including other connectors nearby. Multiple sensors are especially effective at mitigating false signal situations. This is because multiple sensors offer several observations of the same connection. In addition, if a sensor on a first connector is experiencing a power loss, it is likely that the sensor on the second connector has sufficient power, in cases where each connector has an independent power source. Collectively such a coupling system can provide a robust detection mechanism and eliminate false signaling.

Sensor diversity can also be realized, where connectors can employ multiple sensors to improve detection reliability. The connectors can have multiple sensors with the same detection characteristics. The connectors can also have multiple sensors with different detection mechanisms. For example, one sensor can detect a connection and disconnection, while another sensor can detect the distance between the two connectors to indicate a partial disconnection condition. In other cases, the quick connect and quick disconnect coupling may switch among several different modes of detection. For example, if a signal degrades from one sensor, another sensor is automatically or manually switched on. Selection processing can also be used where only one of the sensors' signal is used. In combining processing, each of the sensors send a signal to the processor. Depending on the sophistication of the system, the signals can be used to detect different connection characteristics. Dynamically controlled sensor processing can also be used where the controller can choose from multiple processing schemes. The controller may further send a message to alert the user whenever a sensor is no longer operational.

The electronic indicator typically lies on or within a connector's main body. The indicator assembly may be integrated into the second or first connector in order to provide visual, audible, or tactile confirmation of a proper connection. In another embodiment, the indicator assembly may be formed within an annular ring assembly, which can be attached to a connector during manufacturing, post manufacturing before the sale of the connector, or post manufacturing after the sale of connector.

In another embodiment of the present disclosure, an electronic quick connect/disconnect system comprises: a first component having a tube coupling end; a second component having a tube coupling end with a receiving opening therein to receive the tube coupling end of the first component; one or more electronic sensors, wherein at least one of the sensors is configured to sense a coupled condition between the first and second components when in a coupled condition; an electronic locking mechanism associated with the first and second components to lock them together in locked condition, allow easy disconnection when desired, and provide for detection of locked condition; a controller configured to generate a message responsive to the current condition provided from the at least one sensor; one or more indicators configured to provide a message responsive to the controller generating the message, wherein said indicator is an electronic display device; and a wireless transceiver configured to wirelessly transmit a message to a wireless base station, device, or app.

Embodiments of the disclosure related to electronic quick connect/disconnect systems and methods for connecting and disconnecting fluid dispensing devices. The devices can be spigots, faucets, hoses, pipes, sprinklers, nozzles, wands, other hose attachments, fluid supply sources for non-garden devices, or combination thereof. The fluid supply source can be, for example, a water pipe or a valve. The system includes a main body or frame and a locking body abuts to the main body for protecting internal components. The main body and the locking body include an outer wall defining a surface that is easily gripped by a user for releasing or disengaging a connecting body. In one embodiment, the locking body converts rotational motion to linear motion to lock a male connecting body into a female connecting body and provides a sensor to detect a locked condition. In one embodiment, a second housing may be provided for receiving the male connecting body and protecting other internal components. The locking body engaging an outer wall of the second housing further provides protection to the internal components retained in the first and second housings.

In several embodiments, the sensor portions are further comprised of a first sensor ring assembly positioned outwardly from the coupling end portion of the first connector, where the first sensor ring assembly comprised of at least one sensor, and a first locking assembly configured to lock the coupling end portion with respect to the first sensor ring assembly. A second sensor ring assembly positioned outwardly from the coupling end portion of the second connector, where second sensor ring assembly comprised of at least one sensor, and a second locking assembly configured to lock the tube coupling end portion of the second connector with respect to said second sensor ring assembly.

In several embodiments, the indicator is further comprised of an indicator ring assembly within the second connector and indicator ring assembly comprised of at least one indicator, and a locking assembly configured to lock the coupling end portion with respect to the indicator assembly.

In another embodiment, the system may also include a base station, which is compact and indicates the connection status of the connectors. The base station may be housed within an electronic spigot. An electronic spigot includes an electronic valve unit for attachment to a standard type outdoor hose faucet, sillcock, bib, or pipe and to which can be attached a garden hose to control the flow of water such as to a garden hose sprayer device attached to the hose. The spigot includes two electronic quick connect/disconnect couplers to connect to a hose and the faucet, sillcock, bib, or pipe. The electronic connectors in the entire fluid system communicates messages to base station of the valve unit by means of radio frequency (RF) signals, Bluetooth, Wi-Fi, Bluetooth, Bluetooth Low Energy, Infrared, or any combination thereof.

A signal or message receiver unit housed within the base station receives the signals or messages and displays the status of the connectors by means of radio frequency (RF) signals, Bluetooth, Wi-Fi, Bluetooth, Bluetooth Low Energy, Infrared, or any combination thereof. By providing display capabilities, a user can decide whether to turn the water on and off, based on whether the connectors are properly coupled. Each transmitter unit of a connector sends an individual code in the signal in message and the receiver unit will not respond thereto unless programmed to recognize the code of that transmitter unit housed within a connector. This feature helps avoid inadvertent cross-signaling or cross-messaging by adjacent users with the same type of system. The electronic connectors which are directly attached to the electronic spigot may communicate with the base station so that it is not necessary to use the transmitter and receiver units for the connectors directly attached to the spigot.

The controller unit normally comprises a housing containing the electrical circuitry including a microcontroller, wireless receiver, and one or more memory chips, along with one or more batteries to power the system. A control panel thereof includes one or more displays, such as a set of light emitting diodes, a liquid crystal display (LCD) or other type of displays to indicate the statuses of the connectors to the user. The control unit further includes an electrical control device which contains one or more of the following: a function switch, a rotary knob, a set of switches, a set of buttons, a touch pad, and a touch panel/screen. For example, in the case of a rotary knob, the rotary knob is rotated toward an opened position and a closed position to control the water flow level. As another example, in the case of increase and decrease flow buttons, the buttons are pressed, respectively, to increase and decrease the level of water flow. Yet another example, in the case of a touch pad or screen, the pad or screen is pressed to control the level of water flow.

The valve unit component is like any electronic spigot or irrigation controller on the market today which typically comprises a body having inlet and outlet connections for attachment to a hose faucet and to a standard garden hose, and a water valve is interposed between the inlet and outlet connections and is operatively connected to an electric solenoid valve or the like which controls the water flow based on the instructions sent by the controller. What differs is that the electronic spigot contains a receiver unit which receives signals or messages from the connectors. The receiver unit's electrical circuitry includes a microcontroller (with one or more memory chips therein) that determines whether the electronic valve is shut off or opened based on whether connectors are properly coupled. The electronic spigot may also include a solar panel, a charging unit for charging electronic connectors, a mounted electronic key pad or conventional key actuator for access control, a mounting post, a remote control, and a light emitting diode fixture for night usage. The body (or housing unit) itself may be mounted directly to a wall or on a post.

The electronic quick connect/disconnect system is provided for receiving at least one fluid dispensing device or source, such as a spigot. The system is compact and easy to manufacture using standard methods in the industry.

In general, in one aspect, an embodiment features an electronic quick connector for forming a severable connection in a fluid system, comprising: a body having a bore therethrough, wherein the body comprises (i) an attachment end configured to connect the bore in fluid flow relationship to a fluid flow channel, and (ii) a coupling end configured to connect the bore in fluid flow relationship to a coupling end of a further electronic quick connector; a holding mechanism configured to secure the coupling end of the electronic quick connector in a receiving opening of a coupling end of the further electronic quick connector responsive to the coupling end of the further electronic quick connector being inserted into and fully received in coupling condition in the receiving opening, and to release the coupling end of the electronic quick connector from the receiving end when desired to disconnect the electronic quick connector from the further electronic quick connector; and at least one sensor configured to: (i) detect a plurality of coupling conditions of the electronic quick connector and the further electronic quick connector, wherein the coupling conditions include the connected condition and a disconnected condition, and (ii) provide an electronic signal representing the coupling condition detected by the at least one sensor.

Embodiments of the electronic quick connector may comprise one or more of the following features. Some embodiments comprise a locking mechanism configured to secure the coupling end of the electronic quick connector to the coupling end of the further electronic quick connector in a locked condition; wherein the at least one sensor is further configured to detect the locked condition. Some embodiments comprise at least one electronic indicator configured to indicate the locked condition detected by the at least one sensor. Some embodiments comprise at least one electronic indicator configured to indicate the coupling condition detected by the at least one sensor. in some embodiments the at least one electronic indicator is selected from the group consisting of: an electronic visual indicator; an electronic audible indicator; and an electronic tactile indicator. In some embodiments the at least one electronic indicator is formed on an annular structure. Some embodiments comprise a locking assembly configured to lock the at least one electronic indicator to the electronic quick connector. Some embodiments comprise a transmitter configured to transmit a message representing the coupling conditions detected by the at least one sensor. Some embodiments comprise a transceiver configured to transmit a first message representing the coupling conditions detected by the at least one sensor and to receive a second message from a transmitter. Some embodiments comprise one or more electrical output pins configured to output the electronic signal provided by the at least one sensor. In some embodiments the coupling conditions further include a partially connected condition; and the at least one sensor is further configured to detect the partially connected condition. Some embodiments comprise at least one electronic indicator configured to indicate the coupling condition detected by the at least one sensor. In some embodiments the coupling conditions further include (i) a connecting condition wherein the electronic quick connector and the further connector are being joined, and (ii) a disconnecting condition wherein the electronic quick connector and the further connector are being separated; and the at least one sensor is further configured to detect the connecting condition and the disconnecting condition. Some embodiments comprise at least one electronic indicator configured to indicate the coupling condition detected by the at least one sensor. Some embodiments comprise the electronic quick connector and the further electronic quick connector. In some embodiments the further electronic quick connector comprises: at least one further sensor; wherein, to detect the plurality of coupling conditions of the electronic quick connector and the further electronic quick connector, the at least one sensor of the quick connector is further configured to detect the at least one further sensor of the further quick connector. In some embodiments the further electronic quick connector comprises: at least one further sensor configured to detect one of the coupling conditions; and at least one further electronic indicator configured to indicate the coupling condition detected by the at least one further sensor. In some embodiments the further electronic quick connector comprises a coupling end and an attachment end; and the locking mechanism comprises: at least one object retaining hole through the coupling end of a first one of the electronic quick connector and the further electronic quick connector, an object movably disposed in the at least one object retaining hole, a sleeve slidably mounted on the coupling end and over the at least one object retaining hole of the first one of the electronic quick connector and the further electronic quick connector, a spring for biasing the sleeve to a biased position, and an object receiving recess for receiving the object in the at least one object retaining hole; wherein responsive to the coupling end of the electronic quick connector and the coupling end of the further electronic quick connector being brought together in the connected condition and the sleeve being in the biased position, the recess is configured to receive the object; and wherein the at least one sensor is further configured to detect whether the sleeve is in its biased locked position. In some embodiments the object is selected from the group consisting of: a ball; a pin; and a tab. In some embodiments the object receiving recess is an annular groove. In some embodiments relative rotation of the electronic quick connector with respect to the further electronic quick connector is inhibited responsive to the object being in the recess when the connectors are in the connected condition. In some embodiments relative rotation of the electronic quick connector with respect to the further electronic quick connector is not inhibited responsive to the object being in the recess when the connectors are in the connected condition. Some embodiments comprise a processor; one or more user-operable controls; and electronic circuitry in electrical communication with the processor, the at least one sensor, and the one or more user-operable controls. Some embodiments comprise a circuit board; wherein the processor is disposed upon the circuit board. Some embodiments comprise a power source configured to provide power to the processor. In some embodiments the attachment ends of the electronic quick connectors are threaded for attachment to fluid flow lines. Some embodiments comprise an irrigation sprinkler system, wherein the fluid flow lines form part of an irrigation sprinkler system. In some embodiments the at least one sensor comprises: a magnetic sensor. In some embodiments the at least one sensor comprises: a proximity sensor. In some embodiments the at least one sensor is selected from the group consisting of: an NFC sensor, an RFID sensor, a strain sensor, a piezoelectric sensor, an ultrasonic sensor, a pressure sensor, a temperature sensor, an optical sensor, a capacitive sensor, an inductive sensor, a resistive sensor; and a flow sensor. In some embodiments the locking mechanism comprises: a movable mechanical part; wherein the at least one sensor detects a position of the movable mechanical part. In some embodiments the electronic signal comprises a first electronic signal and a second electronic signal; and the at least one sensor comprises: a first sensor configured to (i) detect the connected condition, and (ii) provide the first electronic signal, wherein the first electronic signal represents the connected condition, and a second sensor configured to (i) detect the disconnected condition, and (ii) provide the second electronic signal, wherein the second electronic signal represents the disconnected condition. Some embodiments comprise at least one electronic indicator configured to indicate the coupling condition detected by the at least one sensor. In some embodiments the at least one sensor is formed on an annular structure. Some embodiments comprise a locking assembly configured to lock the at least one sensor to the electronic quick connector. Some embodiments comprise a user-operable control; and a valve disposed within the bore, wherein the valve is configured to move to a plurality of flow control positions responsive to operation of the user-operable control. Some embodiments comprise at least one electronic indicator configured to indicate a current flow control position of the valve. Some embodiments comprise an electronic motor configured to move the valve responsive to operation of the user-operable control. Some embodiments comprise a further valve disposed within the bore, wherein the further valve is configured to move to a plurality of flow control positions; and a further electronic motor configured to move the further valve responsive to operation of the user-operable control. In some embodiments the valve and the further valve are arranged in series. In some embodiments the valve and the further valve are arranged in parallel. In some embodiments a fluid dispensing head attached to the attachment end. Some embodiments comprise a fluid dispensing head attached to one of: (i) the attachment end of the electronic quick connector; and (ii) an attachment end of the further electronic quick connector. In some embodiments the fluid dispensing head is selected from the group consisting of: a handheld nozzle; a shower head; a spigot; a sprinkler; and a faucet. Some embodiments comprise a fluid source attached to the attachment end of the electronic quick connector. In some embodiments the fluid source is a base for mounting a fluid dispensing device. Some embodiments comprise a device, separate from the electronic quick connector, the device comprising (i) a wireless transceiver configured to receive the message, and (ii) at least one electronic indicator configured to indicate the coupling condition represented by the message. In some embodiments the device is selected from the group consisting of: a base station; a remote control; a computer; a smartphone executing an app; and a tablet computer executing an app. Some embodiments comprise at least one of: a spigot; an irrigation controller; a fluid flow control timer; and a shower system; a utility box; a bollard; and a wall-mounted box. Some embodiments comprise a first portion of an electrical circuit; wherein the further electronic quick connector comprises a second portion of the electrical circuit; wherein in one of the coupling conditions the first portion and the second portion join to form an electrical circuit; wherein, responsive to the electrical circuit being formed, the at least one sensor is further configured to (i) detect the one of the coupling conditions, and (ii) provide an electronic signal representing the one of the coupling conditions. Some embodiments comprise at least one electronic indicator configured to indicate the one of the coupling conditions responsive to the at least one sensor providing the electronic signal representing the one of the coupling conditions. In some embodiments the at least one electronic indicator is selected from the group consisting of: an electronic visual indicator; an electronic audible indicator; and an electronic tactile indicator. Some embodiments comprise a transmitter configured to transmit a message representing the one of the coupling conditions responsive to the at least one sensor providing the electronic signal representing the one of the coupling conditions.

In general, in one aspect, an embodiment features an apparatus comprising a base; a connection adapted to connect to a source of fluid; a water outlet; an electronic dispensing device; at least one electronic quick connect and disconnect coupling comprising a first connector having a coupling end with a surface configured with at least one sensor thereof, and an attachment end adapted to be connected in fluid flow relationship to a fluid flow line; a second connector having a coupling end with a receiving opening to receive the coupling end of the first connector therein and having a surface configured with at least one sensor to sense the sensor of the coupling end of the first connector therein in a coupling condition only when the at least one sensor of the surface of the first coupling end communicates with the at least one sensor of the surface of the second receiving opening, and an attachment end adapted to be connected in fluid flow relationship to a fluid flow line; a holding mechanism associated with the first connector and the second connector to secure the coupling end of the first connector in the receiving opening of the coupling end of the second connector when the coupling end of the first connector is inserted into and fully received in coupling condition in the receiving opening and to release the coupling end of the first connector from the receiving opening when desired to disconnect the first connector from the second connector; sensors on the first connector and the second connector cooperating to indicate when the connectors are in coupling condition, as the connectors are joined and moved into coupling condition, and as the connectors are released and separated from coupling condition; wherein the sensors on the first connector and the second connector include at least one sensor positioned on one of the first and second connectors and at least one sensor positioned on the other of the first and second connectors which senses the at least one sensor on the other when the connectors are in coupled condition; electronic circuitry; one or more user-operable controls; a first circuit board connected with the at least one sensor and the electronic circuitry; a cover enclosing the first circuit board to protect the first circuit board; one or more electronic indicators disposed within the second connector; a second circuit board getting power and grounding source from its own power supply, the second circuit board comprising a system on chip, an IoT transceiver configured to transmit a message from the connector and receive a message into the connector; a cover enclosing the second circuit board to protect the second circuit board; a power supply configured to provide power to the second circuit board; and a system on chip comprising a microcontroller, memory, and interfaces, wherein the microcontroller is configured to generate a message in the form of an electronic signal responsive to the current connection state of the first connector in relation to the second connector; wherein each indicator is configured to provide the message responsive to the microcontroller generating the message.

In general, in one aspect, an embodiment features an apparatus comprising: a base; a connection adapted to connect to a source of fluid; a water outlet; an electronic dispensing device; at least one electronic quick connect and disconnect coupling comprising a first connector having a coupling end with a surface configured with at least one sensor thereof, and an attachment end adapted to be connected in fluid flow relationship to a fluid flow line; a second connector having a coupling end with a receiving opening to receive the coupling end of the first connector therein and having a surface configured with at least one sensor to sense the sensor of the coupling end of the first connector therein in a coupling condition only when the at least one sensor of the surface of the first coupling end communicates with the at least one sensor of the surface of the second receiving opening, and an attachment end adapted to be connected in fluid flow relationship to a fluid flow line; a holding mechanism associated with the first connector and the second connector to secure the coupling end of the first connector in the receiving opening of the coupling end of the second connector when the coupling end of the first connector is inserted into and fully received in coupling condition in the receiving opening and to release the coupling end of the first connector from the receiving opening when desired to disconnect the first connector from the second connector; sensors on the first connector and the second connector cooperating to indicate when the connectors are in coupling condition, as the connectors are joined and moved into coupling condition, and as the connectors are released and separated from coupling condition; wherein the sensors on the first connector and the second connector include at least one sensor positioned on one of the first and second connectors and at least one sensor positioned on the other of the first and second connectors which senses the at least one sensor on the other when the connectors are in coupled condition; electronic circuitry; one or more user-operable controls; a first circuit board connected with the at least one sensor and the electronic circuitry; a cover enclosing the first circuit board to protect the first circuit board; one or more electronic indicators disposed within the second connector; a second circuit board , the second circuit board comprising a system on chip, an IoT transceiver configured to transmit a first message from the connector and receive a second message into the connector; a cover enclosing the second circuit board to protect the second circuit board; a power supply configured to provide power to the second circuit board; and a system on chip comprising a microcontroller, memory, and interfaces, wherein the microcontroller is configured to generate a third message in the form of an electronic signal responsive to the current connection state of the first connector in relation to the second connector; wherein each indicator is configured to provide the message responsive to the microcontroller generating the third message.

Embodiments of the apparatus may comprise one or more of the following features. Some embodiments comprise a base station, separate from the connectors, the base station comprising (i) a wireless transceiver configured to receive the first message, and (ii) an electronic indicator configured to indicate the coupling condition represented by the first message. Some embodiments comprise electronic circuitry; a body mounted on a mounting structure and including an electrical control device seat and one or more outlets; a control assembly fixed on the control assembly seat of said body and including at least one valve member and an electrical control device to control the at least one valve member; in the case of a rotary knob, the rotary knob being rotated toward an opened position and a closed position proportionally controlling the level of water flow; in the case of increase/decrease flow buttons, the buttons being pressed to control the level of water flow; a water pipe set including a water inlet pipe and at least one outlet pipe communicating with the at least one valve member of the control assembly to guide water into at least one valve member and to guide water out of the outlet of said body via at least one valve member; at least one valve, secured on at least one outlet pipe and opened to flow the water and closed to stop the water; a plurality of electronic sensing devices mounted on the electrical control device; wherein, in the case of a rotary knob, when the rotary knob is rotated toward the opened position, the electronic control device sends a signal accordingly to open the valve, thus flowing the water; when the rotary knob is rotated toward the closed position, the electronic control device is adjusted accordingly, hence the electronic control device sends an electrical signal to close the valve, thus stopping the water; wherein, in the case of a set of flow buttons, when the increase flow button is pressed, said electronic control device adjusts accordingly to open the valve, thus flowing the water; when the decrease flow button is pressed, the electronic control device is adjusted accordingly, hence the electronic control device sends an electrical signal to close said valve, thus stopping the water. In some embodiments the electronic indicator comprises: an electrical control device seat having a plurality of notches formed thereon; a light shield disposed on each of the notches; and a plurality of light emitting diodes mounted in the notches, wherein the light emitting diodes are configured to indicate at least one status of the at least one electronic quick connect and disconnect coupling. In some embodiments the at least one status is selected from the group consisting of: power on or off; battery charge level; coupling condition; and connector network status. In some embodiments the electronic dispensing device is selected from the group consisting of: a shower system; a spigot; a sprinkler; and a faucet.

### DESCRIPTION OF DRAWINGS

The leading digit(s) of each reference numeral used in this specification indicates the number of the drawing in which the reference numeral first appears.

The above-described features and advantages, as well as others, should become more readily apparent to those of ordinary skill in the art by reference to the following detailed description and the accompanying figures in which:

FIGS. 1A-1D are block diagrams representing an electronic quick connect/disconnect system configured to perform the techniques disclosed herein, in accordance with an embodiment;

FIG. 2 is a block diagram of FIGS. 1A-1C, in accordance with an embodiment of the disclosure;

FIG. 2A is a side view of FIG. 2, in accordance with an embodiment of the disclosure;

FIG. 2B is a side view of FIG. 2, in accordance with an embodiment of the disclosure, wherein a female connector is connected to a spigot and a male connector is connected to a hose;

FIG. 2C shows elements of a connector, in accordance with an embodiment of the disclosure.

FIG. 3 is a side elevational view of the electronic quick connector according to one embodiment, which includes an electronic valve;

FIG. 4, an exploded side elevational view corresponding to FIG. 3 showing the individual electronic components thereof;

FIG. 4A, lateral vertical sectional view taken on the line 4a-4a of FIG. 4 showing the sensors on the male connector;

FIG. 4B, a lateral vertical sectional view taken on the line 4b-4b of FIG. 4 showing the sensors on the female connector;

FIG. 5 is a side elevational view of the electronic quick connector according to one embodiment which includes an electronic valve;

FIG. 6, an exploded side elevational view corresponding to FIG. 5 showing the individual electronic components thereof;

FIG. 6A, lateral vertical sectional view taken on the line 6a-6a of FIG. 6 showing the sensors on the male connector;

FIG. 6B, a lateral vertical sectional view taken on the line 6b-6b of FIG. 6 showing the sensors on the female connector;

FIG. 7A, a side view of an electronic lawn sprinkler utilizing the electronic quick connector to attach a sprinkler head to an extension tube to a base or directly to a base;

FIG. 7B, a side view of an electronic lawn sprinkler utilizing the electronic quick connector to attach a sprinkler head on an extension tube to a base or directly to a base;

FIG. 7C, a side view an electronic lawn sprinkler utilizing the electronic quick connector to attach a sprinkler head on an extension tube to a base or directly to a base;

FIG. 8A, a perspective view of an electronic spigot utilizing the electronic quick connector to attach a hose to an electronic spigot and an electronic quick connector to connect to a fluid source;

FIG. 8B, a side view of an electronic spigot body;

FIG. 8C, a side view according to one embodiment, illustrating both an above-ground and in-ground installation of an electronic spigot utilizing the electronic quick connector to attach a hose to an electronic spigot and an electronic quick connector to connect to a fluid source;

FIG. 8D, a side view of an electronic spigot head utilizing the electronic quick connector to attach a hose to an electronic spigot and an electronic quick connector to connect to a fluid source;

FIG. 9 is a cross-sectional view of a connecting member of FIG. 2, in accordance with an embodiment of the disclosure;

FIG. 10 is a perspective view of a connecting member of FIG. 9, in accordance with an embodiment of the disclosure;

FIG. 11 is a side view of a connecting member of FIG. 9, in accordance with an embodiment of the disclosure;

FIG. 12 is a cross-sectional view of a hose, sprinkler, or nozzle connector that may be used in the system; in accordance with various embodiments of the disclosure;

FIG. 13 is a side view illustrating the system, in accordance with various embodiments of the disclosure;

FIG. 14 is a perspective view illustrating the system, in accordance with various embodiments of the disclosure;

FIG. 15 is a side view illustrating the system, in accordance with various embodiments of the disclosure;

FIG. 16A is a side elevational view of the electronic quick connector according to one embodiment, which includes an electronic valve;

FIG. 16B, an exploded side elevational view corresponding to FIG. 16A showing the individual electronic components thereof;

FIG. 17 is a cross-sectional view of a second body of the quick connect/disconnect system of FIG. 2 including a first and second plan view, first and second end views.

FIG. 18 is a side view of a fluid system, as described herein, including a nozzle, a first coupler system, a hose, a second coupler system, and a sillcock;

FIG. 19 is a rear elevational view of a male connector;

FIG. 20 is a flowchart illustrating a method of operating the electronic fluid system of FIG. 18;

FIG. 21 is a side view of the fluid system of FIG. 18 shown in disconnected configuration;

FIG. 22 is a perspective view of a nozzle apparatus including a male connector integrally formed therewith;

FIG. 23 is a cross sectional view of a nozzle apparatus including a male connector integrally formed therewith;

FIG. 24 is a cross sectional view of a nozzle apparatus including a male connector integrally formed therewith;

FIG. 25 is block diagram of the electronic coupler system of the fluid system; and

FIG. 26 is a diagram of an embodiment where each electronic quick connector includes a portion of an electrical circuit and a coupling condition is detected when the portions are brought together to form an electrical circuit.

### DETAILED DESCRIPTION

For the purpose of providing an understanding of the principles of the disclosure, reference will now be made to the embodiments illustrated in the drawings and described in the following specification. It is understood that no limitation to the scope of the disclosure is thereby intended. It is further understood that this disclosure may include any alterations and modifications to the illustrated embodiments and includes further applications of the principles of the disclosure.

An electronic quick connect/disconnect system may be structured and formed in a variety of different ways. In one example, an electronic quick connect/disconnect system may be formed with an integrated external locking body or frame for receiving a male connecting member. In another example, an electronic quick connect/disconnect system may be formed with an internal locking body or frame.

The flow of electricity may be activated when an operator pushes an on/off switch to the on position and the flow of electricity may be broken when an on/off switch is pushed to the off position. The sensors may be located along or against the connecting coupling of the female connector and male connector, making an electrical connection between the various components.

In some embodiments, the electronic quick connect and disconnect coupling for forming a connection in a fluid system includes a first connector having a coupling end with a surface configured with at least one sensor portion thereof, and an attachment end adapted to be connected in fluid flow relationship to a fluid flow line; a second connector having a coupling end with a receiving opening to receive the coupling end of the first connector therein and having a surface configured with at least one sensor to sense the sensor of the coupling end of the first connector therein in a coupling condition only when the at least one sensor of the surface of the first coupling end communicates with the at least one sensor of the surface of the second receiving opening, and an attachment end adapted to be connected in fluid flow relationship to a fluid flow line; an electronic locking mechanism associated with and lockingly cooperable between the first connector and the second connector to secure the coupling end of the first connector in the receiving opening of the coupling end of the second connector when the coupling end of the first connector is inserted into and fully received in coupling condition in the receiving opening and to release the coupling end of the first connector from the receiving opening when desired to disconnect the first connector from the second connector; sensors on the first connector and the second connector cooperating to indicate when the connectors are in coupling condition, as the connectors are joined and moved into coupling condition, and as the connectors are released and separated from coupling condition; wherein the sensors on the first connector and the second connector include at least one sensor positioned on one of the first and second connectors and at least one sensor positioned on the other of the first and second connectors which senses the at least one sensor on the other when the connectors are in coupled condition; electronic circuitry; one or more user-operable controls which may include buttons, capacitive sensors, slide switches, an on/off switch, touch screens, and the like; a first circuit board assembled in or on the first connector and connected with the at least one sensor and the electronic circuitry and getting power from its own power supply or a second circuit board; a cover enclosing the first circuit board to protect the first circuit board; one or more electronic indicators disposed within second connector which may include electronic visual luminous indicators, electronic audible indicators, and electronic tactile indicators; a second circuit board getting power and grounding source from its own power source, the second circuit board comprising a system on chip, an IoT transmitter configured to transmit a message from the connector, and an IoT receiver, the at least one sensor electrically connected to the circuitry, the second circuit board electrically connected respectively to the at least one indicator and the at least one sensor; a cover enclosing the second circuit board to protect the second circuit board; a power supply configured to provide power to the second circuit board; the system on chip comprising a microcontroller, memory, a microprocessor or DSP cores, interfaces, wherein said microcontroller is configured to generate a message responsive to the current connection state of the first in relation to the second connector; wherein each indicator is configured to provide the message responsive to the microcontroller generating the message.

The system on chip (SoC) may be comprised of both hardware and software for controlling the microcontroller, microprocessor or DSP cores, peripherals and interfaces. The SoC and wireless communications chip may be integrated as a single-chip solution, specifically designed to support the speed, reliability, and quality requirements of the electronic quick connector.

The microcontroller may execute connector specific applications stored in the memory. The microcontroller may include digital signal controllers, analog-to-digital converters, digital-to-analog converters, and the like. The microcontroller may communicate with other elements of the connector over one or more communication busses. The transceiver may employ any communication protocol, including wired and wireless communication protocols. The wireless protocols may include Bluetooth, Bluetooth Low-Energy (BLE), Radio Frequency (RF), Wi-Fi, Digital Enhanced Cordless Telecommunications (DECT), cellular, near-field communications (NFC), ZigBee, Z-Wave, 6LowPAN, Thread, Sigfox and the like. The transmitter may employ multiple communication protocols. The user-operable controls may include buttons, capacitive sensors, slide switches, on/off switches, touch screens, and the like.

The sensors may include magnetic sensors, contact sensors, proximity sensors, limit sensors, and the like. A connector's sensors are electronic components whose purpose is to detect events or changes in a connector's configuration and relay the information to other electronics within the connector, such as the controller. Sensors may sense when two connectors are coupled or when they are decoupled. Sensors provided in the locking mechanism may sense when the locking mechanism is locked or unlocked. Sensors may be spaced circumferentially at certain degree intervals around a sensor ring.

Various sensors which may be used in various embodiments: contact sensors, which detect contact with another sensor; limit sensors, which detect when a subcomponent has moved to the end of its range; and magnetic sensors, such as Reed switches and Hall effect sensors, which use a magnetic field to close or open the circuit. The electrical circuit may be “on” when the magnet is near the sensor which occurs when the connector is in a connected position and, when the connector is in disconnected position, the sensor switch is “off”. Multiple sensors may be bundled together to ensure redundancy in case a sensor fails. Different types of sensors may also be bundled together. Sensors may immediately inform the microcontroller that a connection is coupled or decoupled via a signal. Sensors may be installed on the male connector, the female connector, or both. When a connection is made, the sensor signals to the controller that a connection event has occurred, and, similarly, when a connection is broken, the sensor signals to the controller that a disconnection event has occurred. In one embodiment of the disclosure, a controller can sense a partial connection, where multiple sensors may be aligned to sense partial connections. A partial connection may indicate to a user that a connector has been improperly coupled.

Hall effect sensors are one suitable technology for use with the electronic quick connect/disconnect connector. Hall effect sensors are semiconductor integrated circuits (ICs) with embedded Hall effect sensing elements are used all over the world in everyday products for measuring position. These magnetic sensor devices are used in personal electronics, industrial systems, medical devices, automobiles, aircraft, and spacecraft. Although there are other magnetic sensing technologies, Hall effect continues to be the most prevalent due to its unique set of advantages. First, they are inexpensive: ICs that incorporate Hall effect elements are mass produced with standard CMOS processing flows. Second, they are highly reliable. Being solid-state sensors that measure magnetic fields without requiring physical contact, devices can operate for decades. Third, they are simple: while the inside of an IC incorporates thousands of complex circuits, the outside of most devices only has 3 pins. The output pin is a simple indicator of the proximity to a magnet, and standard microcontrollers can directly read it. Fourth, they offer superior distance sensing: magnetic fields travel a distance and pass through most substances undisturbed. This allows sensors to be integrally located within connectors and are shielded from the environment and invisible to the user.

The connector system may use a proximity sensor which is a sensor able to detect the presence of nearby objects without any physical contact. A proximity sensor typically emits an electromagnetic field or a beam of electromagnetic radiation (infrared, for instance), and looks for changes in the field or return signal. The object being sensed is often referred to as the proximity sensor's target. Proximity sensors can have a high reliability and long functional life because of the absence of mechanical parts and lack of physical contact between sensor and the sensed object.

Sensors are used in electronic quick connectors to send signals to the microcontroller so that the microcontroller may instruct the transmitter to relay this information to other wireless devices and apps and to instruct indicators to relay this information to a user. With modern advances in system-on-chip microcontroller platforms and communication components, the use of sensors may be easily applied into the field of quick connectors for fluid systems.

The sensor's compact size may be powered by one or more 3VDC+ lithium batteries and employ crystal technology for signal transmission, with a longer battery life than non-lithium batteries. The microcontroller may also utilize learn mode technology, enabling it to work with other systems. Each connector is given a unique identification code at the factory, which makes it possible to register connectors with base stations, different controllers, other devices, and apps. The connectors may transmit using beacon technology, which means a battery and sensor status signal can frequently be transmitted.

The information may be made useful to a user in some way. This could be in the form of a visual indicator, an audible indicator, a tactile indicator, or even an alert to the user, such as email, text, or notification via an app. For example, a simple text alert could be sent when a coupler system is disconnected. Additionally, an interface allows users to proactively check in on one or more connectors. Depending on the application, the user may also be able to perform an action and affect the system. For example, the user might remotely adjust an electronic valve opening via an app on their phone using existing wireless valve technology. Some actions may be performed automatically. Rather than waiting for a user to electronically adjust the flow, a system could adjust the flow automatically via predefined rules.

In one embodiment, an electronic connector sends data to a solid-state base station controller mounted inside a cabinet. The cabinet contains a power supply to distribute power in the cabinet; a detector interface component, to connect to electronic connectors and other controllers; amplifiers (such as Wi-Fi repeaters); the controller itself; a monitor unit; and other components. Battery backups may be installed in a separate cabinet from the controller cabinet. These may also provide battery recharging capabilities to the connectors where the operator recharges the connectors when not in use. Solar panels may be installed on the cabinet for recharging the batteries. The base station receives data from the connectors that inform the controller processor whether connectors are connected or disconnected, so that it can display to and alert operators of any disconnections.

The base station can seamlessly integrate connector data from diverse connector systems, devices and sensors from multiple manufacturers and models. The base station controller is aimed at operators wishing to receive data from the connectors into applications. Data can be collected from a number of locally connected physical devices and sensors. The base station can also be a component of an electronic spigot system. The base station may also provide a charging unit for a plurality of electronic connectors.

Various embodiments provide an electronic quick connect and quick disconnect system which is compact, replaces the conventional connector, and notifies operators of the current connection state. A base station, housed within another irrigation controller, such as an electronic spigot, can provide a fail-safe mechanism which automatically shuts off electronically controlled valves whenever the system detects a disconnection of one or more electronic connectors in the fluid system.

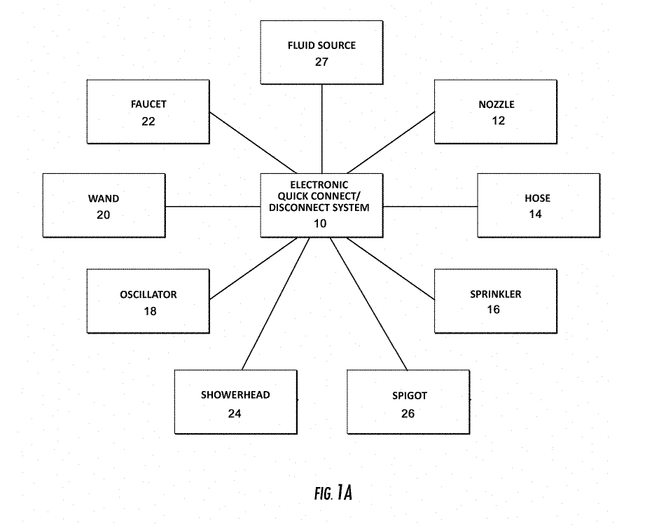

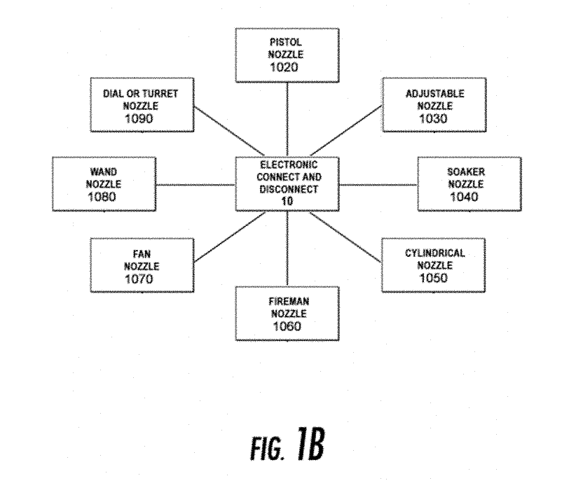

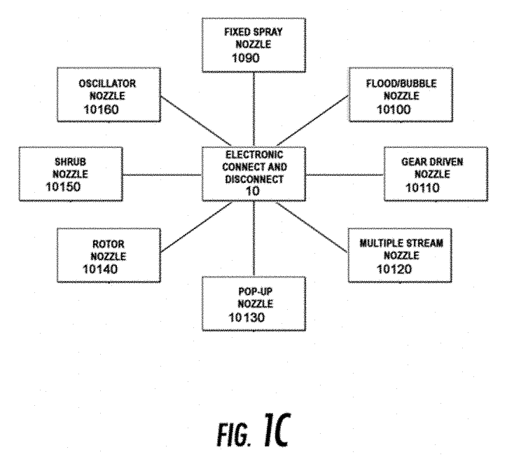

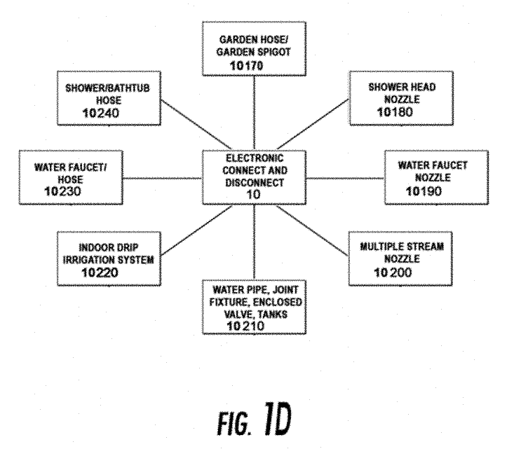

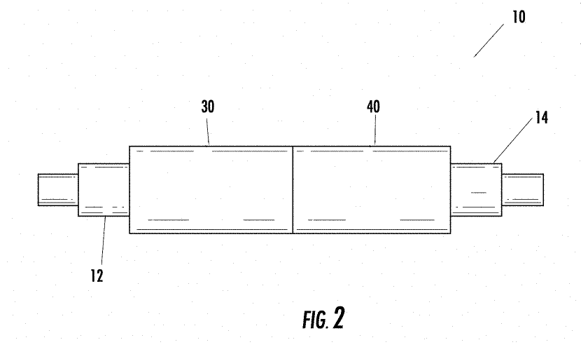

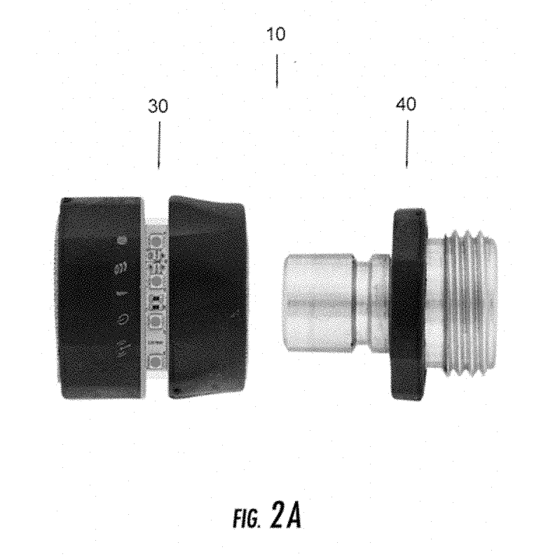

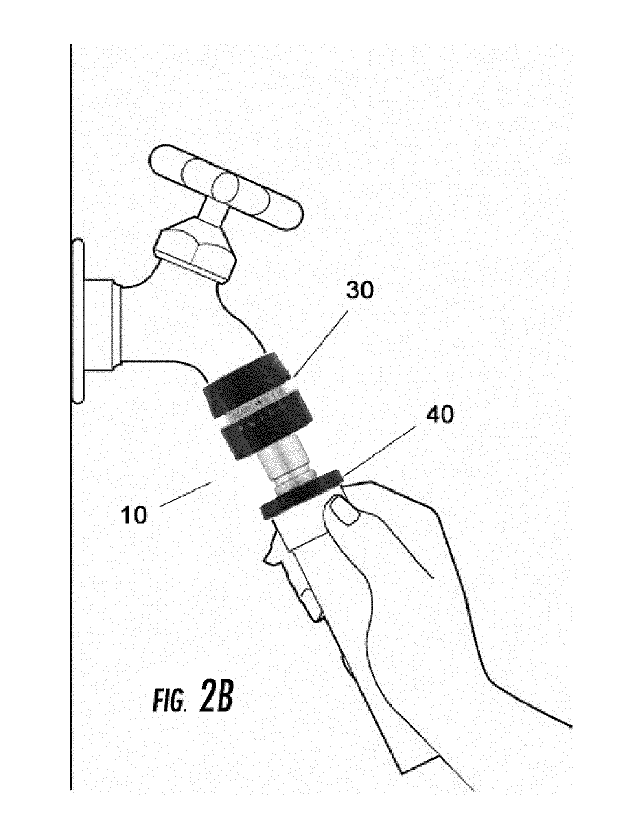

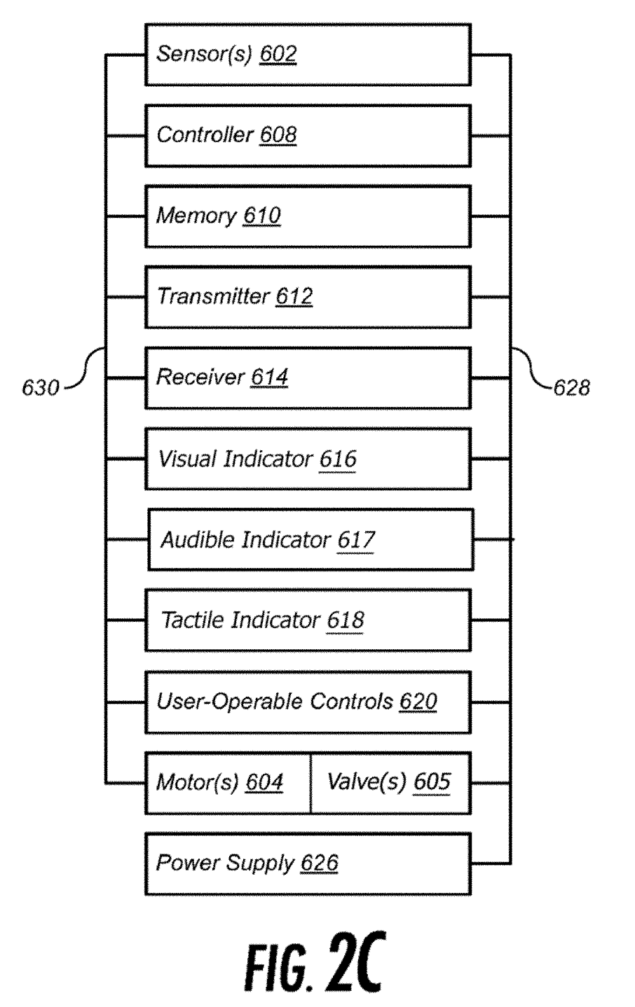

Turning now to the figures, FIGS. 1A to 1D and 2 illustrate the flexibility and usefulness of an electronic quick connect/disconnect system 10 in accordance with one or more of the herein described embodiments. The system 10 provides easy connection and disconnection and easy detection mechanisms to indicate whether a connector is connected or disconnected. A fluid dispensing device can be a nozzle 12, a hose 14, a sprinkler 16, an oscillator 18, a wand 20, a faucet 22, a showerhead 24, a spigot 25, a hose to hose configuration (not shown), other hose attachments, a fluid source 27 for non-garden devices, or combinations thereof. Many other examples of devices are possible. The fluid dispensing device or source may be electronic, and the system can utilize the power supply of the dispensing device or fluid source.

As depicted in FIG. 2, the system 10 includes an electronic female connecting member 30 and a male connecting member 40 interconnected to the electronic female connecting member, eliminating the need for a separate coupler or an adaptor. An electronic indicator assembly may be implemented or integrated into at least one of the connecting members 30, 40. An electronic sensor ring assembly may be implemented or integrated into at least one of the connecting members 30,40. A locking member may be implemented or integrated into one of the connecting members 30, 40. Several locking members will be described in greater detail below.

In one example, a connecting end of the female connecting member 30 is coupled to the nozzle 12 and a connecting end of the male connecting member 40 is coupled to the hose 14, and vice versa. In another example, the connecting end of the female connecting member 30 is coupled to a sprinkler (not shown). It will be understood that certain combinations and subcombinations are of utility and may be employed without reference to other features and subcombinations. For example, a hose to hose system may use an electronic connector.

As depicted in FIG. 2A, a female connecting member 30 couples with a male connector 40, in one embodiment. FIG. 2B is a practical application of the electronic connector, as shown in FIG. 2A, where the female connecting member 30 is coupled to a spigot, and the male connecting member is connected to a garden hose. The electronic aspects of the connector indicate to a user that a connector system is coupled or de-coupled. The design and construction of this embodiment in FIGS. 2A and 2B house compact electronics, as illustrated. In this embodiment, the luminous element ring may be the only form of indicator to the user.

FIG. 2C depicts elements of a quick connect/disconnect connector system. The microcontroller 608, as part of a system-on-chip (SoC), may execute applications stored in the memory 610. The microcontroller 608 may include digital signal controllers, analog-to-digital converters, digital-to-analog converters, and the like. The microcontroller 608 may communicate with other elements of the connector 600 over one or more communication busses 630. The transmitter 612 and receiver 614 which are the communication components of an IoT (or wireless) chip may employ any communication protocol, including wired and wireless communication protocols. The transmitter 612 may employ multiple communication protocols. The user-operable controls 620 may include buttons, capacitive sensors, slide switches, on/off switches, touch screens, and the like. The visual indicator 616 may be comprised of multiple luminous elements. The audible indicator 617 and tactile indicator 618 may also provide an electronic means for indicating a proper coupling.

FIG. 2C shows elements of a connector 600 according to one embodiment. Although in the described embodiment elements of the connector 600 are presented in one arrangement, other embodiments may feature other arrangements. For example, various embodiments may lack one or more of the features shown, such as a connector system which does not provide audible and tactile feedback. In addition, elements of the connector 600 may be implemented in hardware, software, or combinations thereof.

Referring to FIG. 2C, the connector 600 may include one or more each of sensor(s) 602, electric motor(s) 604 and valve(s) 605, a microcontroller 608, a memory 610, a transmitter 612, a receiver 614, one or more user-operable controls 620, and a power supply 626. The connector 600 may include other elements as well. The elements of connector 600 may receive power from the power supply 626 over one or more power circuitry 628. Various elements of the connector 600 may be implemented as one or more integrated circuits. As described in U.S. non-provisional application Ser. No. 15/276,874, a connector 600 may also receive power from the power supply of an electronic fluid device, such as an electronic nozzle, electronic sprinkler, or the like.

The sensors 602 may include contact sensors, magnetic sensors, limit sensors, proximity sensors, and the like. For example, in a connector, a proximity sensor may be utilized to determine the distance of the first connector from the second connector.

Any type of electric valve motor 604 found in prior art may be used in conjunction with a valve 605. In one embodiment, a conventional electric valve motor may be used to rotate a ball valve either linearly or in steps. In another embodiment, a conventional electric valve motor may be used to rotate a disk valve either linearly or in steps. In yet other embodiment, a conventional electric valve motor may be used to raise and lower a lift gate valve either linearly or in steps. The electric valve motor may be connected to the connector's microcontroller for controlling its operation, which either can be performed via a user interface on the connector itself or remotely using the wireless communications module.

Referring to FIGS. 3 and 4, one of the preferred embodiments of the electronic connector is illustrated using components of the present disclosure. For the purpose of promoting a clear understanding, the locking mechanism may be any locking mechanism with at least one sensor positioned to detect the current lock state.

The electronic quick connector 10 comprises a male connector 40; a female connector 30; an indicator 150 comprised of one or more luminous elements; embedded circuitry 125; a power supply 123; a circuit board 122 comprising a microcontroller or microprocessor, memory, and interfaces, and IoT transmitter and IoT receiver; a lock ring assembly 77; a plurality of sensors 95 and 98 on the female connector 30; a tubular sleeve 29; a plurality of sensors 65 and 68 on the male connector 40; a compression spring 32; a lock ring 35; a pair of O-rings 38 and 41; a power switch 121; and a plurality of retaining balls 44. In other embodiments, the retaining balls 44 can be replaced with pins, tabs, other objects, or the like.

Male connector 40 includes an internally threaded portion 47 forming an attachment end integrally connected to a male quick connect or coupling portion or end 50 by means of a shoulder portion 53 intermediate the length of the male connector 40. Male connector 40 further includes a water channel 56 which extends completely through male connector 40, an external ring-shaped retaining groove 59 about coupling portion 50, a ring-shaped surface 62, a circuit board (not shown), a pair of electronic sensors 65 and 68 on shoulder portion 53, and internal circuitry (not shown). Male connector 40 is preferably made of brass or stainless steel, but can be made of aluminum, brass, stainless steel, plastic, polymer, thermoplastic, or of any similar material.

Female connector 30 comprises an externally threaded portion 71 forming an attachment end integrally connected to a female quick connect portion or end 74 by means of a shoulder portion 77. Female connector 30 further includes a water channel 80 which extends completely through female connector 30, a plurality of tapered objects (such as a ball, pin, tab, or the like) retaining holes 83 through female portion 74, an internal annular O-ring groove 86 inside shoulder portion 77, an external annular O-ring groove 89 about externally threaded portion 71 adjacent shoulder portion 77, a ring-shaped surface 92 about shoulder portion 77, and a pair of electronic sensors 95 and 98 formed in female portion 74 by a notch 100 therein. Female connector further includes a power supply 123, a circuit board 122, electronic circuitry 125, an annular luminous ring element 150, and internal circuitry. The circuit board includes a SoC, a memory, and an IoT transceiver. The luminous element ring 150 is electronically connected to the power supply 123 via electrical conductors. The luminous element ring 150 is electronically connected with a control pin of the system-on-chip controller. The luminous element ring 150 may include a plurality of light emitting diodes, a semiconductor laser (not shown) or other electronic components (not shown) which can emit light. The luminous element ring includes an annular translucent cover 151. Female connector 30 is preferably made of brass or stainless steel, but can be made of aluminum, brass, stainless steel, plastic, polymer, thermoplastic, or of any similar material.

Sleeve 29 is preferably made of brass or stainless steel, but can be made of aluminum, brass, stainless steel, plastic, polymer, thermoplastic, or of any similar material.

Lock ring 35 is secured in ring-shaped lock ring groove 112 during assembly after sleeve 29 is slid over female coupling portion 74 with objects 44 in holes 83.

Compression spring 32 biases sleeve 29 against lock ring 35 and comprises a piece of cylindrical metal wound approximately two turns at such a radius as to closely fit about female portion 74 of female connector 30. Spring 32 is preferably made of stainless steel.

Lock ring 35, O-rings 38 and 41, and retaining balls 44 are of standard construction known in the fluid flow industry, and disclosed in prior art, as is the construction of object retaining holes 83 to retain balls 44 therein.

The circuit board which consists of the SoC, the memory unit, and the IoT communications chip (transceiver) are derived from standard technology known in the electronics industries, as is the power switch, the power supply, and the electronic circuitry. The SoC and the IoT chip may be provided as a single-chip solution. A flexible circuit board may also be used. The SoC and the IoT chip may be housed within a cylindrical shell.

Female connector 30, sleeve 29, circuit board 122, electronic circuit 125, power supply 123, luminous element 150, luminous element cover 151, electronic sensors 95 and 98, power switch 121, indicator ring assembly 130, integrated circuitry, compression spring 32, lock ring 35, O-rings 38 and 41, and retaining balls 44 all fit together as shown in FIGS. 3 and 4. When male and female connectors 40 and 30 are connected, sensors 95 and 98 in female portion 74 fit against sensors 65 and 68 on shoulder portion 53. In such a coupled condition, male and female connectors 40 and 30 are electronically or magnetically connected to each other.

When male and female connectors 40 and 30 are connected, sensors 95 and 98 in female connector sense that the female connector is connected to the male connector. For example, sensors detect each other, and when the voltage difference exceeds a set value of the controller, a control signal is emitted from a control pin of the chip to make the luminous element illuminate with an indication of a connected state. A control signal may also be emitted to make an audible indicator or tactile indicator produce indications responsive to the signal received. Furthermore, the transmitter sends a connected state message to the wireless network.

The indicator assembly, the circuit board, the embedded circuitry, the sensor assembly, and the connector may utilize one or multiple layers.

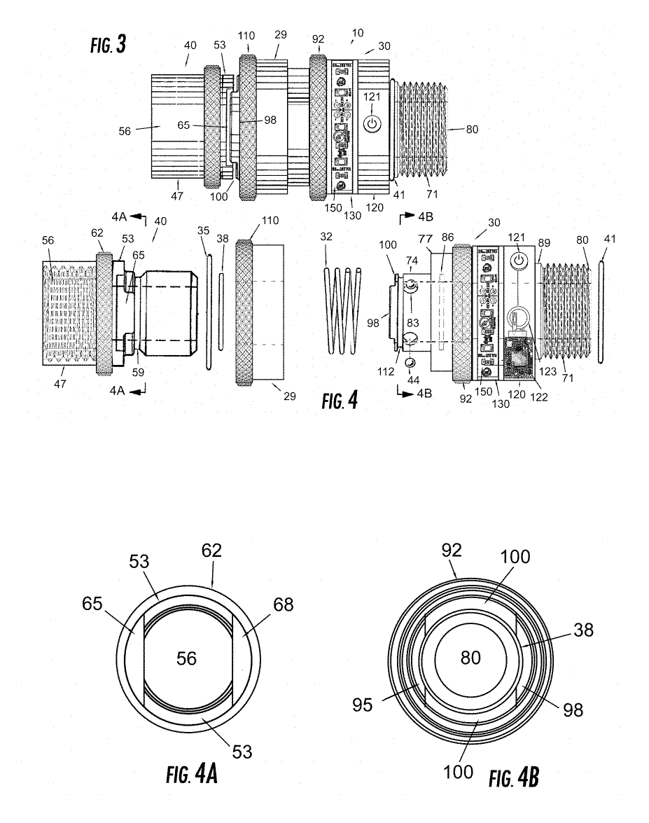

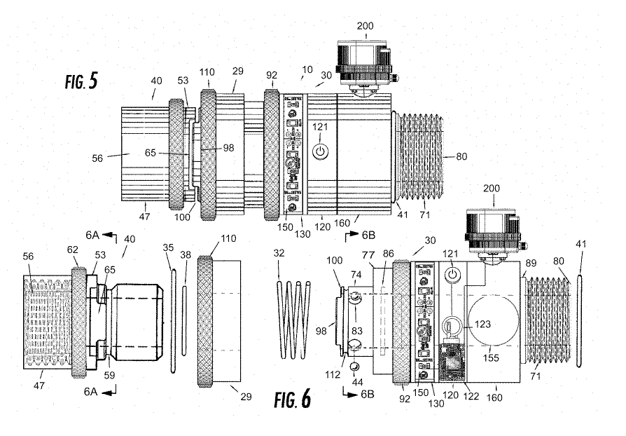

FIGS. 5 and 6 illustrate another embodiment of a quick connect/disconnect system 10. FIGS. 5 and 6 are similar in engineering and construction to the system 10 in FIGS. 3 and 4 and like elements are identified with a like reference numbering convention. In this embodiment, the system 10 includes an electronic valve component 200 as described above and allows fluid to flow through. Any sort of electronic valve 200 may be used.

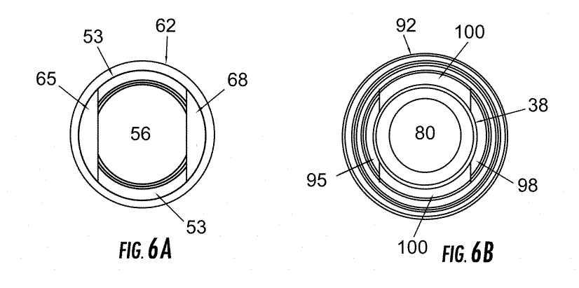

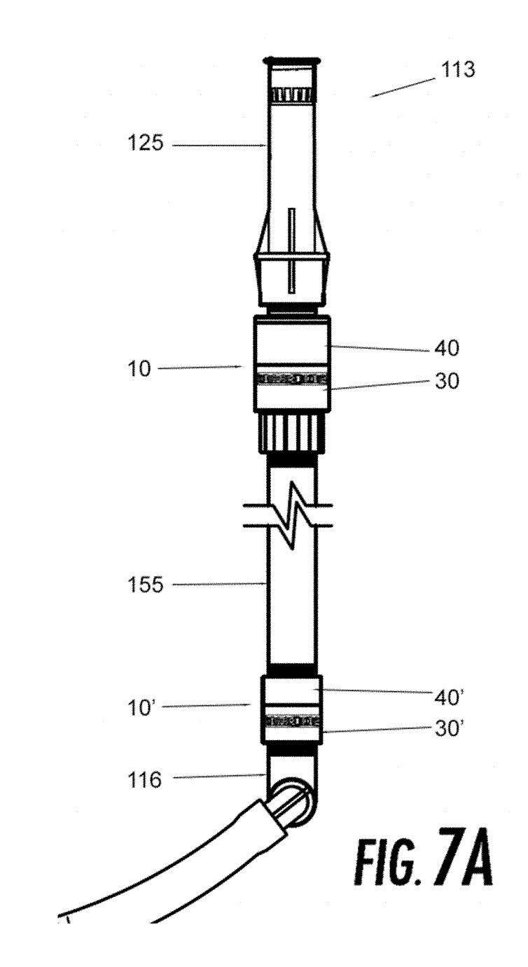

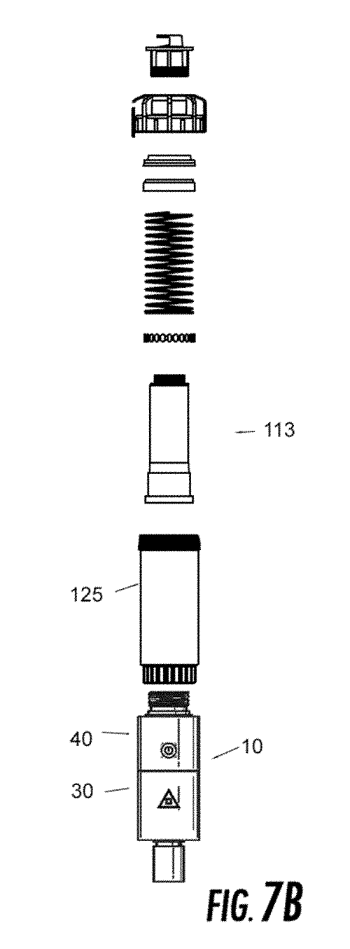

FIGS. 7A to 7C show a plurality of electronic sprinkler applications (as described in U.S. non-provisional application 15/276,874) for electronic quick connector 10. In FIGS. 7A to 7C is shown an electronic sprinkler 113 comprising a base 116 with respective male and female hose couplings and for connection to standard hoses (not shown), an electronic sprinkler head 125, an extension tube (or riser) 155, and quick coupling 10 and quick coupling 10′. One of male and female electronic connectors 40′ and 30′ is threadably connected to base 116 and the other to electronic sprinkler head 125 such that electronic sprinkler head 125 is quickly connectable to base 116. The extension tube (or riser) 155 extends the overall electronic sprinkler's height and interconnects the respective male and female connectors 40 and 30 with electronic sprinkler head 125 and the respective male and female connectors 40′ and 30′ with base 116.

In FIG. 7B is shown a lawn sprinkler 128 comprising a base 116, a sprinkler head 131, and quick coupling 10. Sprinkler 113 can be configured to be sprinkler 128 simply by uncoupling male and female connectors 40 and 30 of quick coupling 10 and interchanging sprayer 131 with sprayer 125, each having a respective male or female connector 40 and 26.

In FIG. 7C is shown a sprinkler 134 comprising a base 137 with respective male and female hose couplings 119 and 122, a sprinkler head 140, and quick coupling 10. In FIG. 6 is shown a sprinkler 143 comprising a base 146 with a female hose coupling 122, a sprinkler head 149, and quick coupling 10.

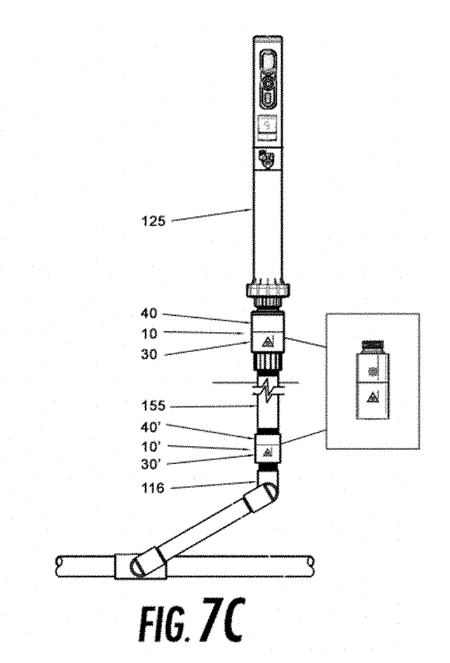

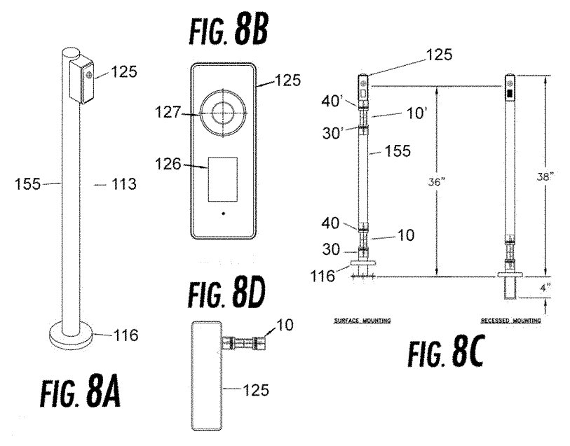

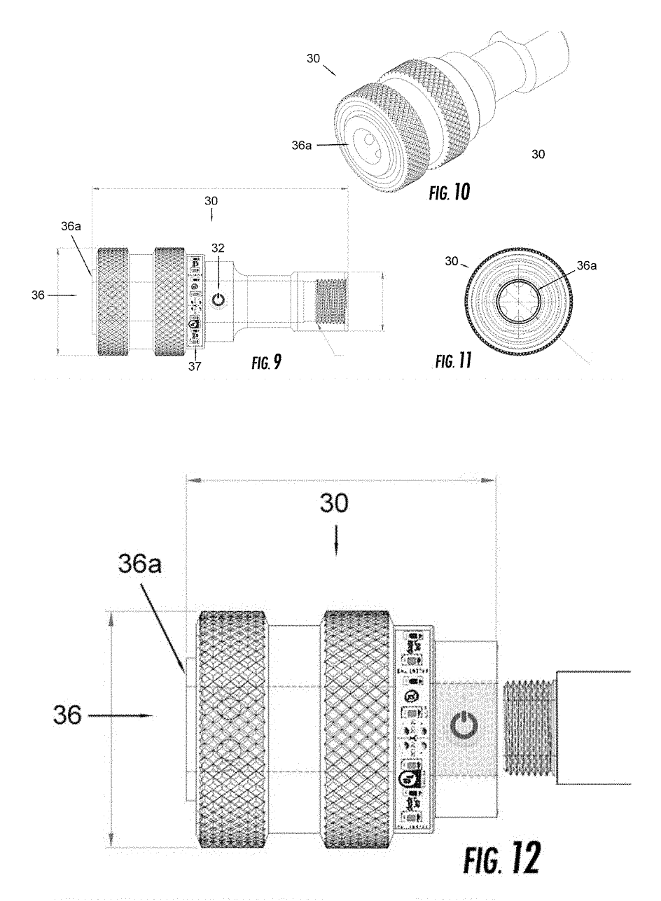

FIGS. 8A to 8B show an electronic spigot for electronic quick connectors 10 and 10′. In FIGS. 8A to 8B, it is shown an electronic spigot 113 comprising a base 116 with respective male and female hose couplings 119 and 122 for connection to standard hoses (not shown), an electronic spigot 125, a cylindrical extension tube 155, quick connectors 10 and 10′. One of male and female electronic connectors 40 and 30 is threadably connected to base 116 and the other to tube such that electronic spigot 125 is quickly connectable to tube 155. The extension cylindrical tube 155 extends the overall electronic sprinkler's height and interconnects the respective male and female connectors 40′ and 30′ with electronic spigot 125. If an operator wishes to connect a hose directly to the electronic spigot, one of male and female electronic connectors 40′ and 30′ is threadably connected to hose and the other to spigot such that electronic spigot 125 is quickly connectable to hose.

Referring to 8A to 8D, the electronic spigot further comprises a communications module for receiving notifications/alerts received from quick connectors. The communications module is installed within the body of the base station.

As shown in FIGS. 8A to 8D, the base post is connected to the body. The spigot controls the valve(s) to open or close, thus starting, stopping, and variably controlling the water supply (e.g. level of water flow) of the spigot. The valves can be provided as any suitable electronical or mechanical actuatable device (e.g., a solenoid variable force controlled valve) that controls the flow of fluids. The post can be of any geometrical shape, such as cylindrical, rectangular, bollard, or the like. The post can be as simple as a plain post or can have controls flush or surface mounted, where the main body is housed within the post. The surface mounted or recessed mounted base allows for an installer to place the electronic spigot/base controller in the most convenient location, thus eliminating the need for longer hoses, etc.

As generally illustrated, the electronic spigot is typically provided as a specific purpose computing device located within a geographical area of electronic connectors. When organized into groups within a particular area (e.g., a residential landscape), hoses coupled to particular valves define a “watering zone” (also referred to simply as a “zone”) within the particular area. In some embodiments, map-based display functionality may be present, enabling a user to view electronic connectors associated with the electronic base station controller in a map-based format.

The input unit for controlling the base station comprises a user interface adapted to be engaged by a user, thereby enabling the user to receive signals from the quick connectors registered with the base station controller.

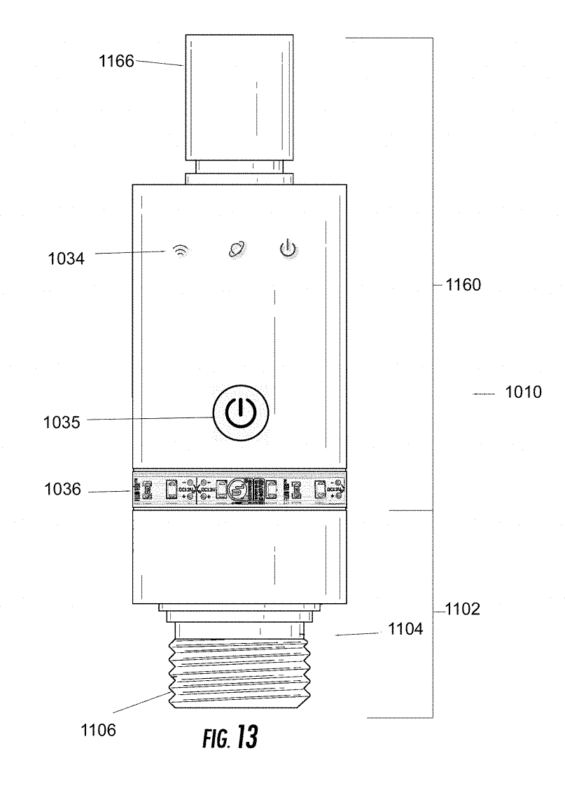

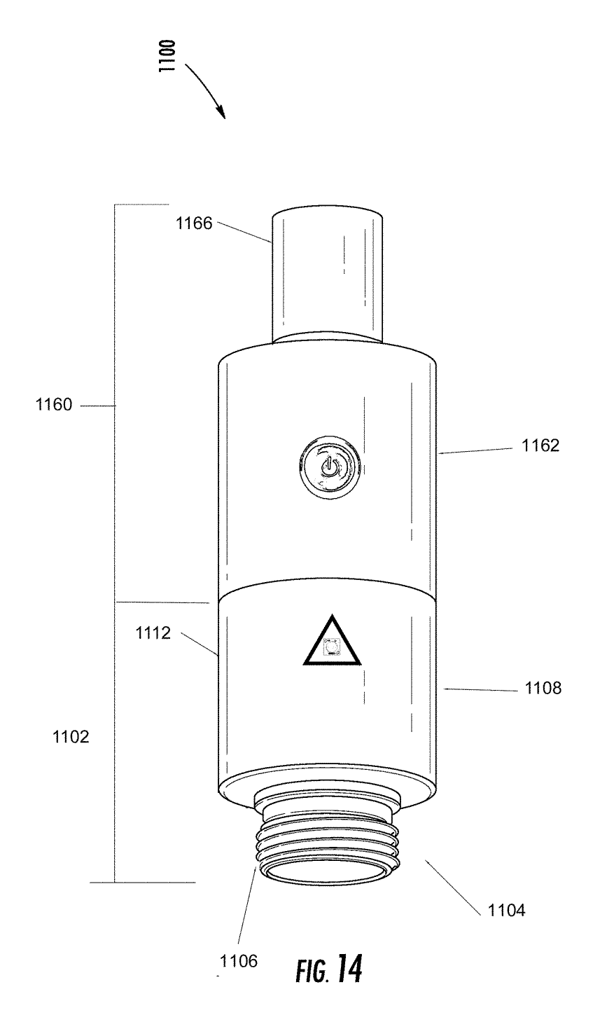

The connecting ends of the connecting members 30, 40 are shown in detail in FIG. 9-12. The female connecting member 30 includes a female tubular sleeve 32 and a connector 36. A plurality of sensors (shown as a ring assembly 36a) communicating with the sensors in the male connecting member may be provided as an outer ring assembly 36a. The power button 32 activates the power of the connector. If a certain time has passed, for example, 10 seconds, without any further connection/disconnection activity, the electronics may be powered to an “off”, “standby” or “sleep” state.

The luminous ring 37 comprised of light emitting diodes, lens cover, and integrated circuitry emits flashing or steady light to indicate to the user that status of a connection.

The connector 36 includes at least one sensor and is illustrated as a sensor ring assembly 36a. When the male connector is inserted into the interior of the connector 36, the sensor ring of the male connector contacts a sensor ring 36a housed within the outward facing wall of the female connector.

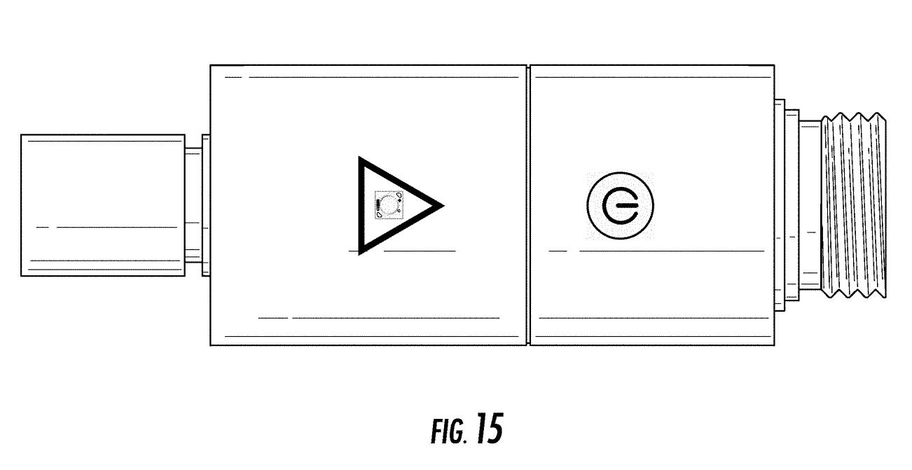

A connecting end of the connector 36 is sized to be substantially conformed to an outer receiving threaded surface of a fluid dispensing device or source. As an example, the connector is a nozzle, sprinkler, or hose connector 36, as illustrated in FIG. 12. FIG. 12 are similar in engineering and construction to the connector in FIGS. 9-11 and like elements are identified with a like reference numbering convention.

The connector may utilize one or multiple layers. The connector may be made of aluminum, brass, titanium, stainless steel, plastic, polymer, thermoplastic, or of any similar material. The indicator assembly of the present disclosure may utilize one or multiple layers. The indicator assembly may be made of aluminum, brass, titanium, stainless steel, plastic, polymer, thermoplastic, or of any similar material. The sensor assembly of the present disclosure may also utilize one or multiple layers. The sensor assembly may be made of aluminum, brass, titanium, stainless steel, plastic, polymer, thermoplastic, or of any similar material.

Although the system 10 shown as two connectors 30, 40 separately coupled to the fluid dispensing devices, it should be understood that numerous variations to the configuration of the system are possible. For instance, the connector 36 may be formed as part of or integrated into one of the connecting members 30, 40. In another example, at least one of the connecting members 30, 40 may be formed as part of or integrated into the fluid dispensing device.

In many of these embodiments, a system 1100 includes a first assembly 1102 and a second assembly 1160. As illustrated in FIG. 13, the first assembly 1102 includes a connector 1104 having a connector end 1106 for receiving a nozzle, for instance. The connector 1104 further includes a passageway and sensors formed on an outer wall of connector 1104. An optical sensor, contact sensor, limit sensor, and the like may be integrated into the system to signal when the system is in connected position. In this embodiment, the system 1100 provides for a larger cylinder within the assemblies 1102, 1160 and allows fluid to flow through and accommodates a larger power supply and electronics.

FIG. 14 illustrates another embodiment of a quick connect/disconnect system 1100. FIG. 14 is similar in engineering and construction to the system 1100 in FIG. 13 and like elements are identified with a like reference numbering convention. The locking structure may be integrated into the system, such as the first housing, second housing, or the locking member. The indicator assembly may be integrated into the system, such as the first housing, second housing or as a separate indicator member. Similarly, the sensor assembly may be integrated into the system, such as the coupling portion of the connector, or as a separate sensor assembly member. In this embodiment, the system 1100 provides for a larger cylinder within the assemblies 1102, 1160 and allows fluid to flow through and accommodates a larger power supply and additional electronics. The locking structure may further have at least one sensor to detect when the coupler is in a locked condition.

FIG. 15 illustrates another embodiment of a quick connect/disconnect system 1100. In this embodiment, the system 1100 includes a larger cylinder within the assemblies 1102, 1160 and allows fluid to flow through and accommodates a larger power supply and electronics.

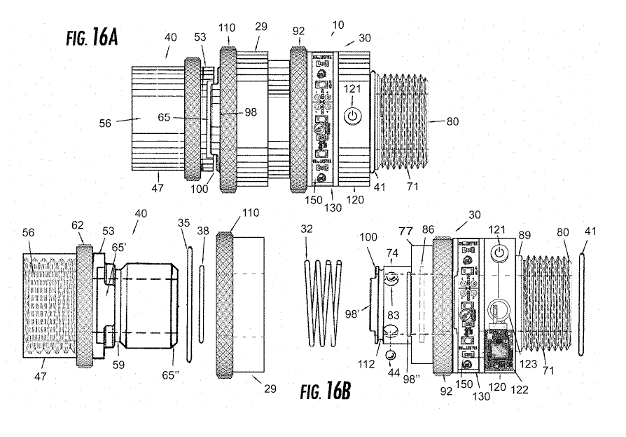

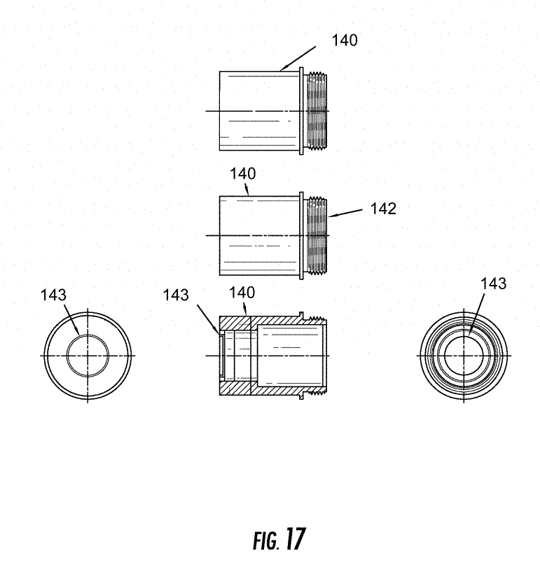

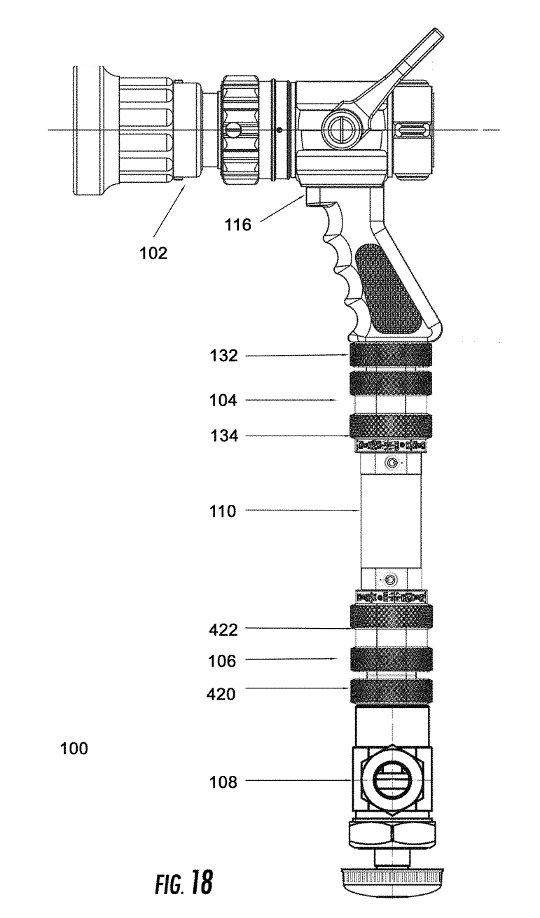

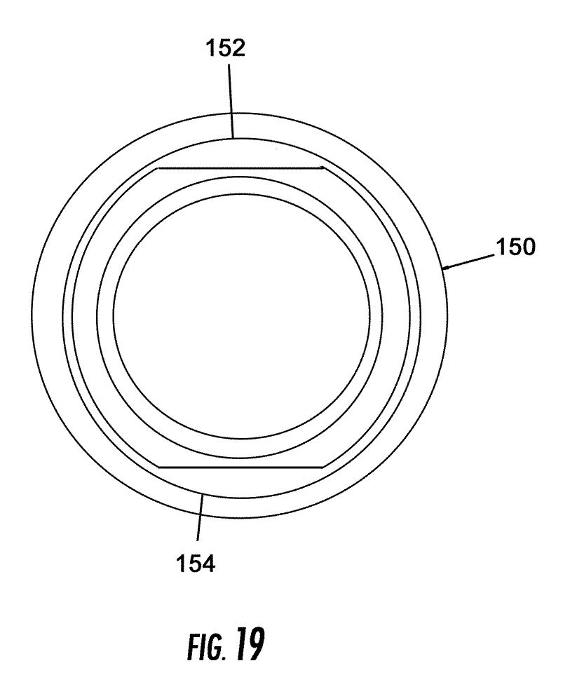

FIGS. 16A-16B illustrate another embodiment of a quick connect/disconnect system 10. FIGS. 16A-16B are similar in engineering and construction to the system 1100 in FIGS. 3-4 and like elements are identified with a like reference numbering convention. A plurality of sensors 98′, 98″ is housed within the female connector and a plurality of sensors 68′, 68″ is housed within the male connector. Each sensor provides a detection mechanism between itself and an external connector, so that the system can determine the proximity of an external connector in relation to itself. This is useful for detecting partial connections and indicating the connection state as a series of indications.

FIG. 17 is a cross-sectional view of the main body 40 of the quick connect/disconnect system's female connector of FIG. 2 including a first and second plan view, first and second end views. The sensor ring is integrated into the connector.

As shown in FIG. 18, a fluid system 100 includes a nozzle 102, a first electronic quick connect/disconnect system, shown as a first coupler system 104, a second electronic quick connect/disconnect system, shown as a second coupler system 106, and a spigot 108. A fluid conduit, shown as a hose 110, connects the first coupler system 104 to the second coupler system 106.

The nozzle 102 is an example of a fluid device that includes a body 116, a valve, and a shaft. The nozzle 102 is representative of any fluid device, such as fluid sprinklers, wands, faucets, electronic or mechanical timers, tanks, containers, accessories, garden wheel reels, and any other fluid device.

In FIG. 18, the coupler system 104 is connected to the nozzle 102 and to the hose 110. The coupler system 104 includes a male connector 132 and a female connector 134. The male connector 132 is connected to the nozzle 102 and is shown as being connected to the female connector 134. In another embodiment, the fluid device 102 is configured to connect to the female connector 134. As illustrated in FIG. 18, both the male connector 132 and the female connector 134 contains sensors, that as a system signal to the controller whether the two connectors are coupled.

As shown in FIG. 19, the connector 142 is substantially circular and includes a first sensor 152 and an opposite second sensor 154. The sensors 152, 154 are configured to contact the corresponding sensors of another connector (not shown).

The tube coupling portion is a cylinder that defines an axial center. The tube coupling portion defines an inside diameter and an outside diameter. The diameters are typically approximately constant along a length of the tube coupling portion, and an outer surface of the tube coupling portion is free from irregularities, however, the diameters may change along the length of the tube coupling portion. In another embodiment, instead of being cylindrical, the tube coupling portion defines a cross section that is elliptical, triangular, square, rectangular, pentagonal, hexagonal, semi-cylindrical, or any other shape as desired. In any components of the system 100 as described herein, similar geometry may be used or applied, including components in the system as depicted in FIG. 2.

The body portion may be formed from stainless steel, brass, aluminum, die cast aluminum, zinc die cast, titanium, polypropylene, thermoplastic, or any other material desired that is suitable for the type of fluid selected to pass through the fluid channel. Furthermore, in some embodiments the body portion is one or more of anodized, chromed, painted, hardened, and any other method that is suitable for the body portion.

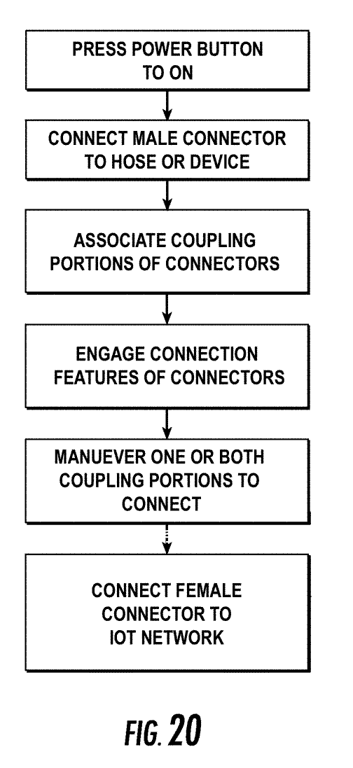

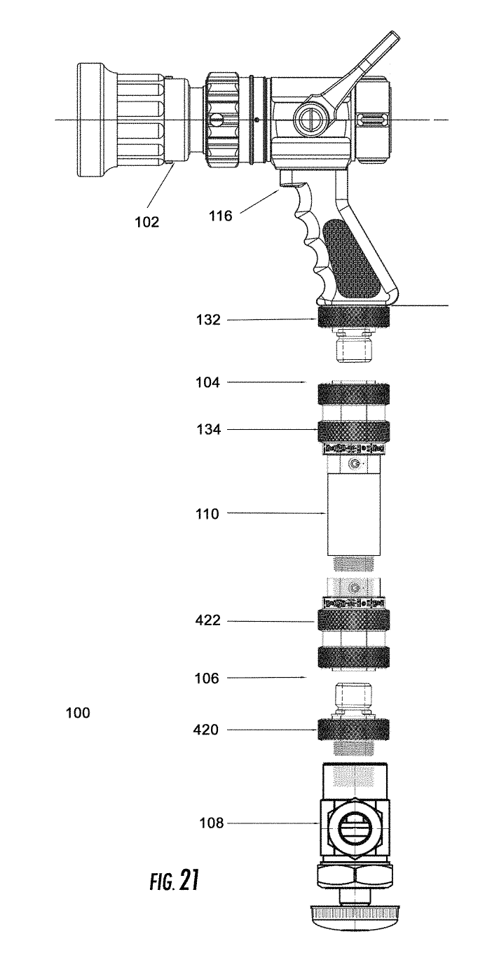

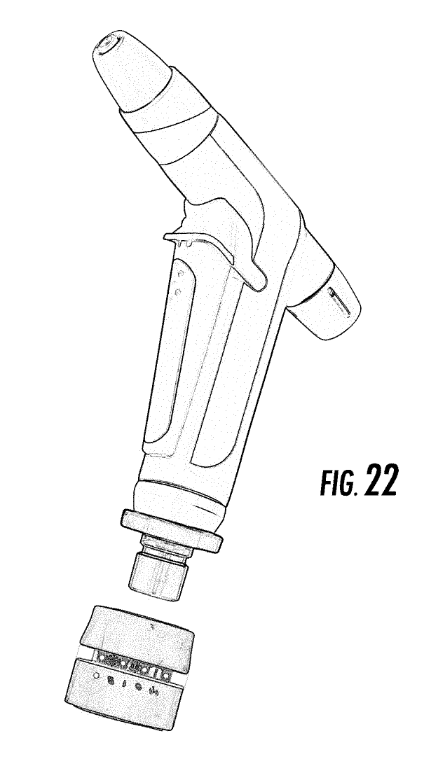

In operation, the fluid system 100 is configured to perform a method shown in FIG. 20, which includes a method of powering on the circuitry, coupling the connectors to one other, and connecting to an IoT network for transmitting and receiving messages.

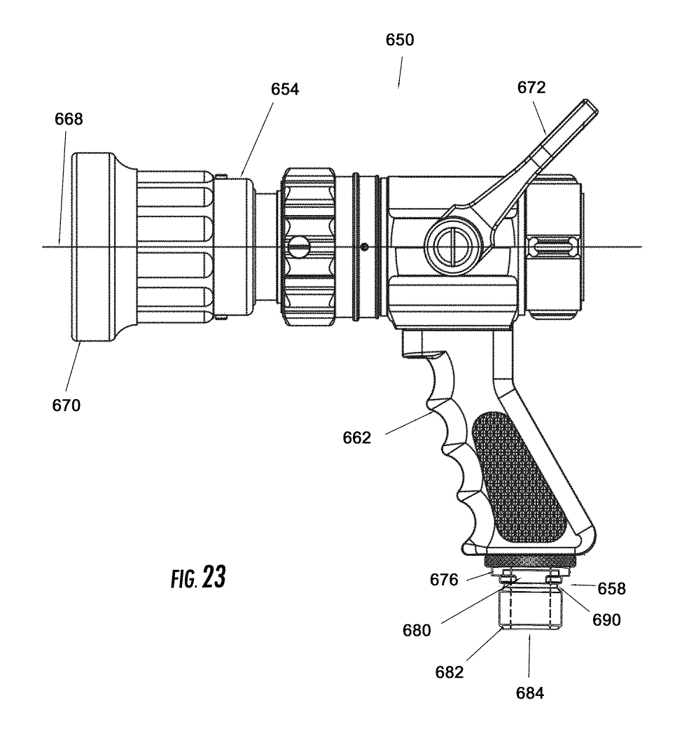

With reference to FIG. 21, the fluid system 100 is shown partially disconnected, with the spigot 108 disconnected from the female connector 422, the male connector 420 disconnected from the male connector 420, and the female connector 134 disconnected from the male connector 132. The fluid system 100 is shown partially disconnected since the male connector 132 is shown, in this example, as being connected to the nozzle 102.

Feedback from Electronic Connectors when Connected

When the male connector 132 is connected to the female connector 134, one or more luminous elements emit light and alert the user that a connection has been established between the male connector 132 and the female connector 134. When the connection occurs, a sound and/or vibration, as tactile feedback, may also be provided to further alert the user that a connection has been established between the male connector 132 and the female connector 134.

When at least one sensor senses a connection, the controller is signaled. In several embodiments, the at least one sensor of either the first connector or the second connector sense that the connectors are coupled. A control signal is emitted from a control pin of the controller chip to make one or more luminous element illuminate according to a set mode of operation. Furthermore, the transmitter transmits a signal or message to a base station, another device, or app.

Feedback from Electronic Connectors when Disconnected

When usage of the nozzle 102 is complete either to store the nozzle or to replace the nozzle with another device, the user disconnects the nozzle from the hose 110 by disconnecting the male connector 132 from the female connector 134. The male connector 132 is moved away from the female connector 134 and the connectors are separated.

When the sensors detect that the connectors are separated or disconnected, the controller is signaled. A control signal may be emitted from a control pin of the chip to make one or more the elements illuminate according to a set mode of operation. Furthermore, the transmitter sends a signal or message to a base station, another device, or app.

Advantages of the Electronic Quick Connect/Disconnect Connector

The electronic connector system 100 offers numerous other advantages. First, users can quickly and easily disconnect a fluid device, such as the nozzle 102, from the hose 100. Second, the male connector 132, 420 and the female connector 134, 422 are quickly and easily connected and disconnected from each other. As illustrated in FIG. 18 and FIG. 21, the locking assembly of the male connector 132, 420 is designed to quickly connect/disconnect the connectors 132, 134, 420, 422, thereby making the connectors easy to operate. The locking assembly may be engineered and constructed differently, however, the electronic quick connector system offers a quick, easy, and convenient approach for connecting a fluid conductor to a fluid source while offering a reliable verification mechanism of physical connections.

When the male connector 132, 420 is connected to the female connector 134, 422 the body portion 136, 426 can either be rotatable or fixed relative to the female connector and the hose 110, using various methods employed in the industry today. Accordingly, when the male connector 132 is connected to the female connector and to the nozzle 102, the nozzle is rotatable relative to the hose 110. A switch can offer a method for switching between rotatable and non-rotatable positions.

As another advantage, when the male connector 132, 420 is connected to the female connector 134, 422, one or more luminous elements emit light in a steady or flashing mode of operation. Furthermore, the transmitter sends a signal or message to a base station, another device or app. Similarly, when the male connector 132, 420 is disconnected to the female connector 134, 422, one or more luminous elements may emit light, while the transmitter may send a signal or message to a base station controller, another device or app. In some embodiments, the female connector may have a test the state, which, in turn, the controller sends a message to a visual indicator to emit light reflecting the current connection state, and to the transmitter to send a signal or message to a base station controller, another device, or app. In other embodiments, the connector may act as a beacon, frequently emitting the current connection state of the connector and

Electronic Connected Coupler

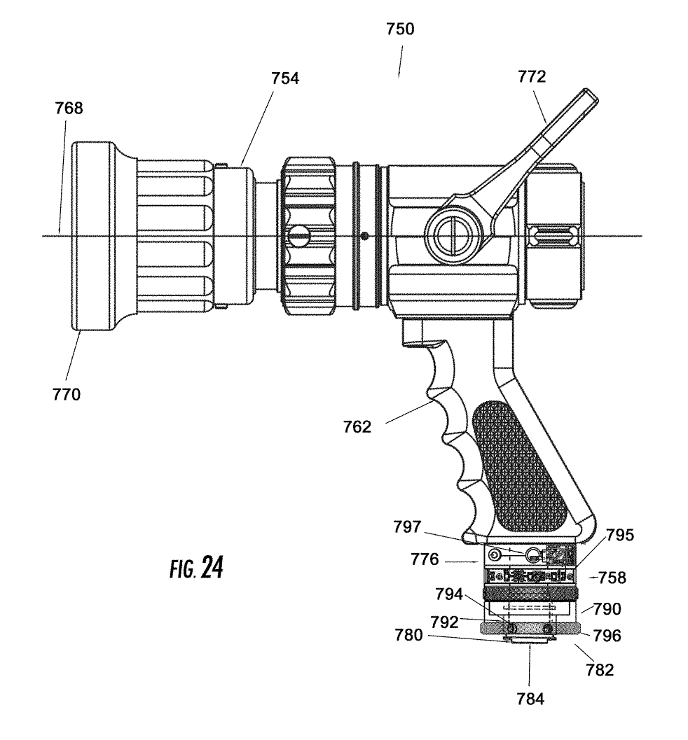

As shown in FIG. 22, a nozzle assembly 650 includes a nozzle apparatus 654 and a male connector 658. As shown in FIG. 23, a nozzle assembly 650 includes a nozzle apparatus 654 and a male connector 658. The nozzle includes a body 662 and a valve. The body defines a fluid channel 668 therethrough. The valve is in a closed position that prevents fluid flow through the end assembly 670 of the nozzle apparatus 654. The valve is movable to an open position in response to movement of a handle 672 of the nozzle apparatus 654. The nozzle apparatus 654, is representative of any fluid device, such as water sprinklers, micro devices, and any other fluid device. The nozzle may also be electronic, as disclosed in U.S. non-provisional application Ser. No. 15/276,874 by the same inventor.

The male connector 658 extends from the nozzle apparatus 654 and includes a body portion 676 and a sensor assembly 680. The body portion 676 is integrally formed with the body 662 of the nozzle apparatus, such that the body portion 676 and the body 662 are a monolithic part. The body portion 676 includes a tube coupling portion 682 and an annular groove 694 and defines a fluid channel therethrough.

The tube coupling portion 682 is substantially identical to the tube coupling portion of the male connector 132. The fluid channel 684 of the body portion 676 is fluidly coupled to the fluid channel (not shown) of the body 662. In another embodiment, the body portion 676 is permanently connected to the body 662.

The mating feature 690 is formed on an external surface of the coupling portion 682 and includes an annular groove, encircling an exterior wall of the coupling portion.

Accordingly, the male connector 658 is configured to connect to the female connector 134, 422 in substantially the same way that the male connector 132 connects to the female connector 134.

The sensor assembly may be in the form of an annular ring assembly. Accordingly, the sensor assembly of the male connector is configured to contact the sensor assembly of the female connector.

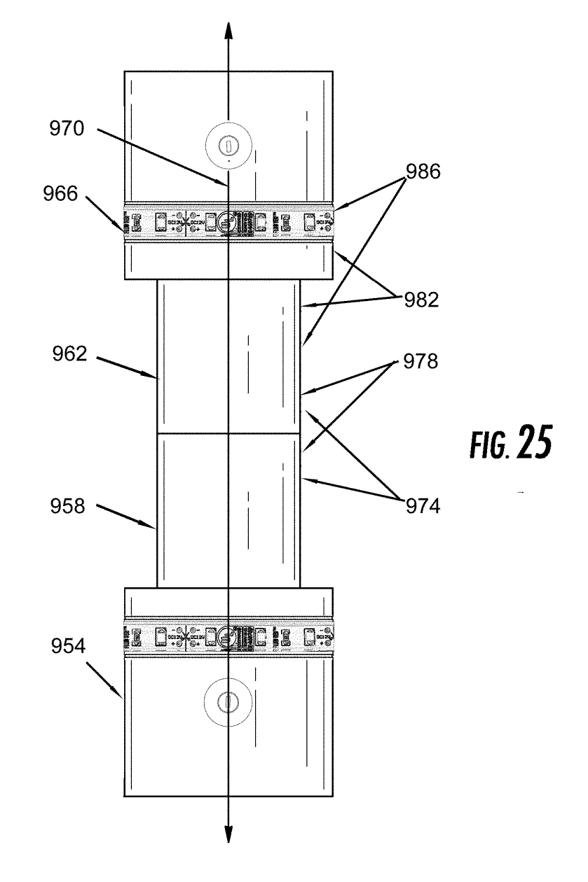

As shown in FIG. 24, a nozzle assembly 750 includes a nozzle apparatus 754 and a female connector 758. The nozzle includes a body 762 and a valve. The body defines a fluid channel 768 therethrough. The valve is in a closed position that prevents fluid flow through the end assembly 770 of the nozzle apparatus 754. The valve is movable to an open position in response to movement of a handle 772 of the nozzle apparatus 654. The nozzle apparatus 754, is representative of any fluid device, such as water sprinklers, micro devices, and any other fluid device. The nozzle may also be electronic, as disclosed in U.S. non-provisional application Ser. No. 15/276,874 by the same inventor.

The female connector 758 extends from the nozzle apparatus754 and includes a body portion 776 and a sensor assembly 780. The body portion 776 is integrally formed with the body 762 of the nozzle apparatus, such that the body portion 776 and the body 762 are a monolithic part. The body portion 776 includes a tube coupling portion 782 and a plurality of balls 794 and defines a fluid channel therethrough. In other embodiments, the balls can be replaced with pins, tabs, or the like.

The balls 794, as shown, are in a fixed relationship with the tube coupling portion 782. The tube coupling portion 782 is substantially identical to the tube coupling portion of the female connector 134. The fluid channel 784 of the body portion 776 is fluidly coupled to the fluid channel (not shown) of the body 762. In another embodiment, the body portion 776 is permanently connected to the body 762.

The mating feature 790 is formed on an internal surface 792 of the coupling ring 786 and includes a plurality of protuberances or objects, provided as balls 794, encircling an inside wall of the coupling portion. The mating feature 790 can be in other forms such as monolithic or added components to the surface. In yet another embodiment, the surface 792 may be altered or modified to form the mating feature 790. The balls 794 extend through passages 796 formed in the coupling portion and are connected to the coupling portion. pin, tab

Accordingly, the female connector 758 is configured to connect to the male connector 132, 420 in substantially the same way that the female connector 134 connects to the male connector 132.

The indicator assembly 795 may be in the form of an annular luminous ring assembly. As illustrated in FIG. 24, the indicator consists of a luminous element component and is configured to alert the user of the current connection state. The sensors 780 may be located in a ring assembly. Accordingly, the sensors within the sensor assembly of the female connector is configured to sense the sensors contained within sensor assembly of the male connector.

The power supply 796 may be provided internally as illustrated, or externally via a power supply in an electronic version of the nozzle 754 as disclosed in U.S. non-provisional application Ser. No. 15/276,874.

Electronic Adjustable Flow Control

As illustrated in FIGS. 5 and 6, a coupling system 10 is modified to enable flow control of the fluid through the coupling system by an off-the-shelf electronic valve assembly. The coupling system 10 includes a male connector 40 and a female connector 30. In this embodiment, the female connector 30 includes a user-interface that is configured to control an electronic valve to each of a plurality of flow positions. In another embodiment, the male connector 40 includes a user interface that is configured to control an electronic valve to each of a plurality of flow positions. The controller is further configured to operate the electronic valve motor responsive to both the current flow control position and the current connection state. For example, if the connectors are disconnected, the microcontroller may be configured to close the valve if the valve is open, or to keep the valve closed if the valve is currently closed, based upon the current connection state of the coupling system.

As shown in FIG. 5, the connectors 30, 40 are shown in a connected position. The electronic valve of the male connector can be controlled via a user-interface to a plurality of orientations which define the flow rate of fluid that passes through the valve. Each of the plurality of valve orientations is a respective one of the plurality of electronic flow control positions, as programmed in the valve controller.

In other embodiments, a coupling system 10 is modified to enable flow control of the fluid through the coupling system by a conventional mechanical valve assembly.

Adapter Apparatus

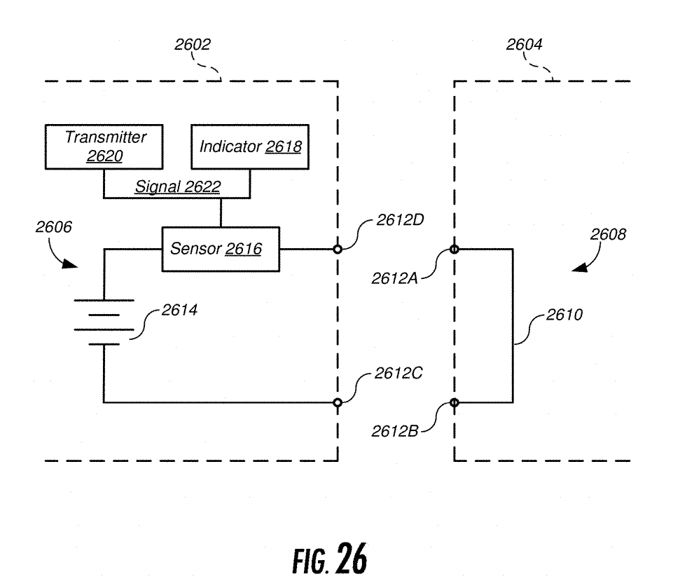

As shown in FIG. 25, a first block 954, a second block 958, a third block 962, and a fourth block 966 define a fluid channel 970 therethrough and used to describe various embodiments of an adapter apparatus. In a first embodiment, block 954 represents the female connector 134, block 958 represents the male connector 132, block 962 represents the male connector 132, and block 966 represents another female connector 134. Accordingly, in this embodiment the adapter apparatus 974 includes blocks 958 and 962 and is a male-male adapter that is used to connect the female connectors 134 of blocks 954 and 966.

In another embodiment, block 954 represents the male connector 132, block 958 represents the female connector 134, block 962 represents the female connector 134, and block 966 represents another male connector 132. Accordingly, in this embodiment the adapter apparatus 978 includes blocks 958 and 962 and is a female-female adapter that is used to connect the male connectors 132 of blocks 954 and 966.

In yet another embodiment, block 954 represents a fluid device such as the nozzle 102, block 958 represents the male connector 132 connected to the nozzle 102, block 962 represents the female connector 134, and block 966 represents any other type of connector, including propriety connectors. Accordingly, in this embodiment the adapter apparatus 982 includes blocks 962 and 966 and is referred to as a female-propriety adapter in the industry.

In a further embodiment, block 954 represents a fluid device such as the nozzle 102, block 958 represents the female connector 134 connected to the nozzle 102, block 962 represents the male connector 132, and block 966 represents any other type of connector, including propriety connectors, as desired. Accordingly, in this embodiment the adapter apparatus 986 includes blocks 962 and 966 and is referred to as a male-propriety adapter in the industry.

When the adapter apparatus 974, 978, 982, 986 is in use, block 954 is fluidly coupled to block 966 as shown by the fluid channel 970.

### Additional Embodiments

In another embodiment, the internal assembly is combined into a single component. For example, the internal assembly is formed as a single component using at least a one stage molding process.

As illustrated in FIG. 18, the hose 110 is terminated with a female connector 420 and a male connector 132. In another embodiment, the hose 110 is terminated with two of the female connectors 420 or two of the male connectors 132.

In yet another embodiment of the coupler system 104, 106, the male connector 132, 420 includes a magnetic sensor system that is configured to sense the connection of the female connector 134, 422 to the male connector 420. The magnetic connection sensor system includes a first magnetic element associated with the male connector 132, 420 and a second magnetic element associated with the female connector 134, 422. The magnetic elements are magnetically attracted to each other to close the electronic circuit of the male connector 132, 420 with the female connector 134, 422. In a similar embodiment, the magnetic elements are magnetically opposed to each other to close the electronic circuit of the male connector 132, 420 with the female connector 134, 422.

In one embodiment each electronic quick connector includes a portion of an electrical circuit and a coupling condition is detected when the portions are brought together to form an electrical circuit. FIG. 26 is a diagram of one such embodiment.

Referring to FIG. 26, a first electronic quick connector 2602 may include a first portion 2606 of an electrical circuit. The first portion 2606 may include a power supply 2614, a sensor 2616, and electrical contacts 2612C and 2612D. A second electronic quick connector 2604 may include a second portion 2608 of an electrical circuit. The second portion 2606 may include an electrical conductor 2610 and electrical contacts 2612A and 2612B.

In one coupling condition the electronic quick connectors 2602, 2604 are brought together such that the first portion 2606 and the second portion 2608 join to form an electrical circuit. In particular, electrical contacts 2612A and 2612D are brought into electrical contact with one another, and electrical contacts 2612B and 2612C are brought into electrical contact with one another, thereby completing an electrical circuit that includes power supply 2614 and sensor 2616. Responsive to the electrical circuit being formed, sensor 2616 detects the coupling condition, and provides an electronic signal 2622 representing the detected coupling condition.

Sensor 2616 may be any sensor that can detect the formation of the electric circuit. For example, sensor 2616 may be a voltage sensor, current sensor, resistive sensor, capacitive sensor, inductive sensor, or the like.

In some embodiments, electronic quick connector 2602 may include an indicator 2618. Responsive to the sensor 2616 providing the electrical signal 2622, the indicator 2618 indicates the coupling condition. The indicator 2618 may be an electronic visual indicator, an electronic audible indicator, an electronic tactile indicator, and the like.

In some embodiments, electronic quick connector 2602 may include a transmitter 2620. Responsive to the sensor 2616 providing the electrical signal 2622, the transmitter 2620 transmit a message representing the coupling condition.

While the illustrated embodiments show male or external threads on the attachment end of the female connector and female or internal threads on the attachment end of the male connector, either end could have either internal or external threads depending upon the particular application for the coupling. Further, the coupling can be used in various components, not just the specific uses shown, such as the electronic sprinkler, electronic nozzle, and electronic spigot.

A number of implementations have been described. Nevertheless, various modifications may be made without departing from the scope of the disclosure. Accordingly, other implementations are within the scope of the following claims.

What is claimed is:

1. An electronic quick connector for forming a severable connection in a fluid system, comprising:
a body having a bore therethrough, wherein the body comprises
(i) an attachment end configured to connect the bore in fluid flow relationship to a fluid flow channel, and
(ii) a coupling end configured to connect the bore in fluid flow relationship to a coupling end of a further electronic quick connector;
a holding mechanism configured to secure the coupling end of the electronic quick connector in a receiving opening of a coupling end of the further electronic quick connector responsive to the coupling end of the further electronic quick connector being inserted into and fully received in coupling condition in the receiving opening, and to release the coupling end of the electronic quick connector from the receiving end when desired to disconnect the electronic quick connector from the further electronic quick connector; and
at least one sensor configured to:
(i) detect a plurality of coupling conditions of the electronic quick connector and the further electronic quick connector, wherein the coupling conditions include the connected condition and a disconnected condition, and
(ii) provide an electronic signal representing the coupling condition detected by the at least one sensor.

2. The electronic quick connector of claim 1, further comprising:
a locking mechanism configured to secure the coupling end of the electronic quick connector to the coupling end of the further electronic quick connector in a locked condition;
wherein the at least one sensor is further configured to detect the locked condition.

3. The electronic quick connector of claim 2, further comprising:
at least one electronic indicator configured to indicate the locked condition detected by the at least one sensor.

4. The electronic quick connector of claim 1, further comprising:
at least one electronic indicator configured to indicate the coupling condition detected by the at least one sensor.

5. The electronic quick connector of claim 4, wherein the at least one electronic indicator is selected from the group consisting of:
an electronic visual indicator;
an electronic audible indicator; and
an electronic tactile indicator.

6. The electronic quick connector of claim 4, wherein:
the at least one electronic indicator is formed on an annular structure.

7. The electronic quick connector of claim 6, further comprising:
a locking assembly configured to lock the at least one electronic indicator to the electronic quick connector.

8. The electronic quick connector of claim 1, further comprising:
a transmitter configured to transmit a message representing the coupling conditions detected by the at least one sensor.

9. The electronic quick connector of claim 1, further comprising:
a transceiver configured to transmit a first message representing the coupling conditions detected by the at least one sensor and to receive a second message from a transmitter.

10. The electronic quick connector of claim 1, further comprising:
one or more electrical output pins configured to output the electronic signal provided by the at least one sensor.

11. The electronic quick connector of claim 1, wherein:
the coupling conditions further include a partially connected condition; and
the at least one sensor is further configured to detect the partially connected condition.

12. The electronic quick connector of claim 11, further comprising:
at least one electronic indicator configured to indicate the coupling condition detected by the at least one sensor.

13. The electronic quick connector of claim 1, wherein:
the coupling conditions further include
(i) a connecting condition wherein the electronic quick connector and the further connector are being joined, and
(ii) a disconnecting condition wherein the electronic quick connector and the further connector are being separated; and
the at least one sensor is further configured to detect the connecting condition and the disconnecting condition.

14. The electronic quick connector of claim 13, further comprising:
at least one electronic indicator configured to indicate the coupling condition detected by the at least one sensor.

15. A quick connection system comprising:
the electronic quick connector of claim 1, and
the further electronic quick connector.

16. The quick connection system of claim 15, wherein the further electronic quick connector comprises:
at least one further sensor;
wherein, to detect the plurality of coupling conditions of the electronic quick connector and the further electronic quick connector, the at least one sensor of the quick connector is further configured to detect the at least one further sensor of the further quick connector.

17. The quick connection system of claim 15, wherein the further electronic quick connector comprises:
at least one further sensor configured to detect one of the coupling conditions; and
at least one further electronic indicator configured to indicate the coupling condition detected by the at least one further sensor.

18. The electronic quick connector of claim 15, wherein:
the further electronic quick connector comprises a coupling end and an attachment end; and
the locking mechanism comprises:
at least one object retaining hole through the coupling end of a first one of the electronic quick connector and the further electronic quick connector,
an object movably disposed in the at least one object retaining hole,
a sleeve slidably mounted on the coupling end and over the at least one object retaining hole of the first one of the electronic quick connector and the further electronic quick connector,
a spring for biasing the sleeve to a biased position, and
an object receiving recess for receiving the object in the at least one object retaining hole;
wherein responsive to the coupling end of the electronic quick connector and the coupling end of the further electronic quick connector being brought together in the connected condition and the sleeve being in the biased position, the recess is configured to receive the object; and
wherein the at least one sensor is further configured to detect whether the sleeve is in its biased locked position.

19. The electronic quick connector of claim 17, wherein the object is selected from the group consisting of:
a ball;
a pin; and
a tab.

20. The electronic quick connector of claim 18, wherein:
the object receiving recess is an annular groove.

21. The electronic quick connector of claim 18, wherein:
relative rotation of the electronic quick connector with respect to the further electronic quick connector is inhibited responsive to the object being in the recess when the connectors are in the connected condition.

22. The electronic quick connector of claim 18, wherein:
relative rotation of the electronic quick connector with respect to the further electronic quick connector is not inhibited responsive to the object being in the recess when the connectors are in the connected condition.

23. The electronic quick connector of claim 1, further comprising:
a processor;
one or more user-operable controls; and
electronic circuitry in electrical communication with the processor, the at least one sensor, and the one or more user-operable controls.

24. The electronic quick connector of claim 23, further comprising:
a circuit board;
wherein the processor is disposed upon the circuit board.

25. The electronic quick connector of claim 23, further comprising:
a power source configured to provide power to the processor.

26. The electronic quick connector of claim 15, wherein:
the attachment ends of the electronic quick connectors are threaded for attachment to fluid flow lines.

27. The electronic quick connector of claim 26, further comprising:
an irrigation sprinkler system, wherein the fluid flow lines form part of an irrigation sprinkler system.

28. The electronic quick connector of claim 1, wherein the at least one sensor is selected from the group consisting of:
a magnetic sensor;
a proximity sensor;
an NFC sensor;
an RFID sensor;
a strain sensor;
a piezoelectric sensor;
an ultrasonic sensor;
a pressure sensor;
a temperature sensor;
an optical sensor;
a capacitive sensor;
an inductive sensor;
a resistive sensor; and
a flow sensor.

29. The electronic quick connector of claim 1, wherein the locking mechanism comprises:
a movable mechanical part;
wherein the at least one sensor detects a position of the movable mechanical part.

30. The electronic quick connector of claim 1, wherein:
the electronic signal comprises a first electronic signal and a second electronic signal; and
the at least one sensor comprises:
a first sensor configured to
(i) detect the connected condition, and
(ii) provide the first electronic signal, wherein the first electronic signal represents the connected condition, and
a second sensor configured to
(i) detect the disconnected condition, and
(ii) provide the second electronic signal, wherein the second electronic signal represents the disconnected condition.

31. The electronic quick connector of claim 30, further comprising:
at least one electronic indicator configured to indicate the coupling condition detected by the at least one sensor.

32. The electronic quick connector of claim 1, wherein:
the at least one sensor is formed on an annular structure.

33. The electronic quick connector of claim 32, further comprising:
a locking assembly configured to lock the at least one sensor to the electronic quick connector.

34. The electronic quick connector of claim 1, further comprising:
a user-operable control; and
a valve disposed within the bore, wherein the valve is configured to move to a plurality of flow control positions responsive to operation of the user-operable control.

35. The electronic quick connector of claim 34, further comprising:
at least one electronic indicator configured to indicate a current flow control position of the valve.

36. The electronic quick connector of claim 34, further comprising:
an electronic motor configured to move the valve responsive to operation of the user-operable control.

37. The electronic quick connector of claim 36, further comprising:
a further valve disposed within the bore, wherein the further valve is configured to move to a plurality of flow control positions; and
a further electronic motor configured to move the further valve responsive to operation of the user-operable control.

38. The electronic quick connector of claim 37, wherein:
the valve and the further valve are arranged in series.

39. The electronic quick connector of claim 37, wherein:
the valve and the further valve are arranged in parallel.

40. The electronic quick connector of claim 1, further comprising:
a fluid dispensing head attached to one of:
(i) the attachment end of the electronic quick connector; and
(ii) an attachment end of the further electronic quick connector.

41. The electronic quick connector of claim 40, wherein the fluid dispensing head is selected from the group consisting of:
a handheld nozzle;
a shower head;
a spigot;
a sprinkler; and
a faucet.

42. The electronic quick connector of claim 1, further comprising:
a fluid source attached to one of:
(i) the attachment end of the electronic quick connector; and
(ii) an attachment end of the further electronic quick connector.

43. The electronic quick connector of claim 42, wherein:
the fluid source is a base for mounting a fluid dispensing device.

44. The electronic quick connector of claim 1, further comprising:
a device, separate from the electronic quick connector, the device comprising
(i) a wireless transceiver configured to receive the message, and
(ii) at least one electronic indicator configured to indicate the coupling condition represented by the message.

45. The electronic quick connector of claim 44, wherein the device is selected from the group consisting of:
a base station;
a remote control;
a computer;
a smartphone executing an app; and
a tablet computer executing an app.

46. The electronic quick connector of claim 44, further comprising at least one of:
a spigot;
an irrigation controller;
a fluid flow control timer;
a shower system;
a utility box;
a bollard; and
a wall-mounted box.

47. The electronic quick connector of claim 1, further comprising:
a first portion of an electrical circuit;
wherein the further electronic quick connector comprises a second portion of the electrical circuit;
wherein in one of the coupling conditions the first portion and the second portion join to form an electrical circuit;
wherein, responsive to the electrical circuit being formed, the at least one sensor is further configured to
(i) detect the one of the coupling conditions, and
(ii) provide an electronic signal representing the one of the coupling conditions.

48. The electronic quick connector of claim 47, further comprising:
at least one electronic indicator configured to indicate the one of the coupling conditions responsive to the at least one sensor providing the electronic signal representing the one of the coupling conditions.

49. The electronic quick connector of claim 48, wherein the at least one electronic indicator is selected from the group consisting of:
an electronic visual indicator;
an electronic audible indicator; and
an electronic tactile indicator.

50. The electronic quick connector of claim 47, further comprising:
a transmitter configured to transmit a message representing the one of the coupling conditions responsive to the at least one sensor providing the electronic signal representing the one of the coupling conditions.

51. An apparatus comprising:
a base;
a connection adapted to connect to a source of fluid;
a water outlet;
an electronic dispensing device;
at least one electronic quick connect and disconnect coupling comprising
a first connector having a coupling end with a surface configured with at least one sensor thereof, and an attachment end adapted to be connected in fluid flow relationship to a fluid flow line;
a second connector having a coupling end with a receiving opening to receive the coupling end of the first connector therein and having a surface configured with at least one sensor to sense the sensor of the coupling end of the first connector therein in a coupling condition only when the at least one sensor of the surface of the first coupling end communicates with the at least one sensor of the surface of the second receiving opening, and an attachment end adapted to be connected in fluid flow relationship to a fluid flow line;
a holding mechanism associated with the first connector and the second connector to secure the coupling end of the first connector in the receiving opening of the coupling end of the second connector when the coupling end of the first connector is inserted into and fully received in coupling condition in the receiving opening and to release the coupling end of the first connector from the receiving opening when desired to disconnect the first connector from the second connector;
sensors on the first connector and the second connector cooperating to indicate when the connectors are in coupling condition, as the connectors are joined and moved into coupling condition, and as the connectors are released and separated from coupling condition;
wherein the sensors on the first connector and the second connector include at least one sensor positioned on one of the first and second connectors and at least one sensor positioned on the other of the first and second connectors which senses the at least one sensor on the other when the connectors are in coupled condition;
electronic circuitry;
one or more user-operable controls;
a first circuit board connected with the at least one sensor and the electronic circuitry;
a cover enclosing the first circuit board to protect the first circuit board;
one or more electronic indicators disposed within the second connector;
a second circuit board, the second circuit board comprising a system on chip, an IoT transceiver configured to transmit a first message from the connector and receive a second message into the connector;
a cover enclosing the second circuit board to protect the second circuit board;
a power supply configured to provide power to the second circuit board; and
a system on chip comprising a microcontroller, memory, and interfaces, wherein the microcontroller is configured to generate a third message in the form of an electronic signal responsive to the current connection state of the first connector in relation to the second connector;
wherein each indicator is configured to provide the third message responsive to the microcontroller generating the third message.

52. The apparatus of claim 51, further comprising:
a base station, separate from the connectors, the base station comprising
(i) a wireless transceiver configured to receive the first message, and
(ii) an electronic indicator configured to indicate the coupling condition represented by the first message.

53. The apparatus of claim 52, further comprising:
electronic circuitry;
a body mounted on a mounting structure and including an electrical control device seat and one or more outlets;
a control assembly fixed on the control assembly seat of said body and including at least one valve member and an electrical control device to control the at least one valve member;
in the case of a rotary knob, the rotary knob being rotated toward an opened position and a closed position proportionally controlling the level of water flow;
in the case of increase/decrease flow buttons, the buttons being pressed to control the level of water flow;
a water pipe set including a water inlet pipe and at least one outlet pipe communicating with the at least one valve member of the control assembly to guide water into at least one valve member and to guide water out of the outlet of said body via at least one valve member;
at least one valve, secured on at least one outlet pipe and opened to flow the water and closed to stop the water;
a plurality of electronic sensing devices mounted on the electrical control device;
wherein, in the case of a rotary knob, when the rotary knob is rotated toward the opened position, the electronic control device sends a signal accordingly to open the valve, thus flowing the water; when the rotary knob is rotated toward the closed position, the electronic control device is adjusted accordingly, hence the electronic control device sends an electrical signal to close the valve, thus stopping the water;
wherein, in the case of a set of flow buttons, when the increase flow button is pressed, said electronic control device adjusts accordingly to open the valve, thus flowing the water; when the decrease flow button is pressed, the electronic control device is adjusted accordingly, hence the electronic control device sends an electrical signal to close said valve, thus stopping the water.

54. The apparatus of claim 53, wherein the electronic indicator comprises:
an electrical control device seat having a plurality of notches formed thereon;
a light shield disposed on each of the notches; and
a plurality of light emitting diodes mounted in the notches, wherein the light emitting diodes are configured to indicate at least one status of the at least one electronic quick connect and disconnect coupling.

55. The apparatus of claim 54, wherein the at least one status is selected from the group consisting of:
power on or off;
battery charge level;
coupling condition;
network status; and
connector network status.

56. The apparatus of claim 51, wherein the electronic dispensing device is selected from the group consisting of:
a shower system;
a spigot;
an irrigation sprinkler;
a micro-irrigation drip system; and
a faucet.
